(19) United States
(12) Patent Application Publication
(10) Pub. No.: US 2025/0350078 A1
(43) Pub. Date: Nov. 13, 2025

(54) MODULAR VEHICLE AND CORRESPONDING ELECTRICAL SYSTEM

(71) Applicant: FORD GLOBAL TECHNOLOGIES, LLC, Dearborn, MI (US)

(72) Inventors: John GALIN, Mill Valley, CA (US); Hussain Z. TAJMAHAL, Detroit, MI (US); Elena OGLE, Columbus, OH (US); Leyna HIRSCH, Livonia, MI (US)

(21) Appl. No.: 18/660,754

(22) Filed: May 10, 2024

(51) Int. Cl. H01R 25/16; H01R 25/14

(52) U.S. Cl. CPC H01R 25/162; H01R 25/142; H01R 2201/26

(57) ABSTRACT

A vehicle electrical system includes a first sleeve, at least one first bus bar, a second sleeve, and at least one second bus bar. The first sleeve defines a first slot extending longitudinally between first and second ends. The first slot is open along a lateral side of the first sleeve. The at least one first bus bar is disposed within the first slot. The second sleeve defines a second slot extending longitudinally between third and fourth ends. The second slot is open along a lateral side of the second sleeve. The at least one second bus bar is disposed within the second slot. The at least one first and second bus bars are configured to collectively engage an electrical connector that is disposed within the first and second slots.

### TECHNICAL FIELD

The present disclosure relates to vehicle frames, vehicle bodies, and other corresponding components.

### BACKGROUND

Vehicles and automobiles include bodies and/or frames that operate as the underlying support structure for the other subsystems of the vehicle (e.g., powertrain systems, steering systems, etc.).

### SUMMARY

A vehicle includes a frame, a first sleeve, a second sleeve, and an electrical connector. The frame has a rail extending longitudinally between forward and rearward regions of the vehicle. The rail defines a T-slot having a head region and a neck region. The T-slot is configured to receive fasteners for mounting vehicle subcomponents and subsystems to the frame. The first sleeve has a first open end defining a first slot, has at least one first bus disposed along an interior surface of the first sleeve within the first slot, and is disposed within the T-slot along a first side of the head region. The second sleeve has a second open end defining a second slot, has at least one second bus disposed along an interior surface of the second sleeve within the second slot, and is disposed within the T-slot along a second side of head region. The electrical connector has a base, electrical contacts disposed on an exterior surface of the base, and an electrical socket extending from the base. A first region of the base is disposed within the first slot such that a first portion of the electrical contacts engages the at least one second first bus. A second region of the base is disposed within the second slot such that a second portion of the electrical contacts engages the at least one second bus. The engagement between the electrical contacts and the at least one first and second buses establishes an electrical connection between the at least one first and second buses and the electrical socket. The electrical connector is movable within the first and second sleeves along the rail. The electrical socket is configured to receive an electrical connector to deliver power or data to a modular component that is securable to and movable along the rail.

An electrical system for a vehicle includes a first sleeve, at least one first electrical bus, a second sleeve, and at least one second electrical bus. The first sleeve is disposed within a channel defined by a vehicle frame, extends longitudinally in a first direction between forward and rearward regions of the vehicle, and defines a first slot. The first slot extends longitudinally in the first direction between the forward and rearward regions of the vehicle. The first slot is open along an edge of the first sleeve. The edge of the first sleeve faces laterally relative to the first direction. The at least one first electrical bus is disposed in the first slot. The second sleeve is disposed within the channel defined by the vehicle frame, is spaced-apart from the first sleeve, extends longitudinally in the first direction between the forward and rearward regions of the vehicle, and defines a second slot. The second slot extends longitudinally in the first direction between the forward and rearward regions of the vehicle. The second slot is open along an edge of the second sleeve. The edge of the second sleeve faces laterally relative to the first direction and toward the edge of the first sleeve. The at least one second electrical bus is disposed in the second slot. The at least one first electrical bus and the at least one second electrical bus are configured to deliver power or data to one or more modular components that are securable to and movable along the vehicle frame.

A vehicle electrical system includes a first sleeve, at least one first bus bar, a second sleeve, and at least one second bus bar. The first sleeve extends longitudinally between first and second ends. The first sleeve defines a first slot extending longitudinally between the first and second ends. The first slot is open along a lateral side of the first sleeve. The at least one first bus bar is disposed within the first slot and extends longitudinally between the first and second ends. The second sleeve extends longitudinally between third and fourth ends. The second sleeve defines a second slot extending longitudinally between the third and fourth ends. The second slot is open along a lateral side of the second sleeve. The at least one second bus bar is disposed within the second slot and extends longitudinally between the third and fourth ends. The at least one first and second bus bars are configured to collectively engage an electrical connector that is disposed within the first and second slots. The electrical connector is movable within the first and second sleeves to deliver power or data to a modular component that is movable between various positions.

### BRIEF DESCRIPTION OF THE DRAWINGS

FIG. 1 is a perspective view of a vehicle, including a corresponding vehicle frame and a cabin section of a vehicle body;

FIG. 2 is a plan view of the vehicle, including the corresponding vehicle frame and the cabin section of the vehicle body;

FIG. 3 is a perspective exploded view of a frame rail and corresponding fastening rail that is secured to the frame rail;

FIG. 4 is a perspective view of an alternative embodiment where the frame rail and fastening rail are formed as an integrated structure;

FIG. 5 is a perspective view of a first type of a mounting structure that is secured to the fastening rail;

FIG. 6 is a perspective view of a second type of a mounting structure that is secured to the fastening rail;

FIG. 7 is a perspective view of a third type of a mounting structure that is secured to the fastening rail;

FIG. 8 is a perspective view of a fourth type of a mounting structure that is secured to the fastening rail;

FIG. 9 is a perspective view illustrating stop pins that are configured to engage the frame rail and fastening rail;

FIG. 10 is a perspective exploded view of the vehicle including a first upfit configuration;

FIG. 11 is a perspective exploded view of the vehicle including a second upfit configuration;

FIG. 12 is a perspective view of the vehicle including a third upfit configuration;

FIG. 13 is a perspective view of an outrigger as secured to the vehicle frame;

FIG. 14 is a perspective view of a storage box that is secured to a secondary fastening rail;

FIG. 15 is a perspective view of a fastening anchor that is configured to engage the fastening rail;

FIG. 16 is a top view of the fastening anchor;

FIG. 17 is a side view of the fastening anchor illustrating the fastening anchor in an engaged position with the fastening rail;

FIG. 18 is a rear view of the fastening anchor illustrating the fastening anchor in a disengaged position with the fastening rail;

FIG. 19 is a rear view of the fastening anchor illustrating the fastening anchor in the engaged position with the fastening rail;

FIG. 20 is a cross-sectional view of the fastening anchor and fastening rail taken along line 20-20 in FIG. 8;

FIG. 21 is a cross-sectional view of the fastening anchor and fastening rail taken along line 20-20 in FIG. 8 illustrating an engagement between the fastening anchor and a fastener;

FIG. 22 is a perspective view of a wire fixation system or wire harness system for a vehicle illustrating a first type of bracket mounting wires to a vehicle frame;

FIG. 23 is a perspective view of the wire fixation system or wire harness system illustrating a second type of bracket mounting wires to the vehicle frame;

FIG. 24 is a front perspective view of the second type of bracket;

FIG. 25 is front perspective view of two brackets that are of the second type positioned adjacent to each other in a back-to-back configuration;

FIG. 26 is a perspective view of the wire fixation system or wire harness system illustrating both the first and second types of brackets mounting wires to the vehicle frame;

FIG. 27 is a perspective view of a vehicle electrical system as secured to the vehicle frame;

FIG. 28 is a perspective view of a first pair of sleeves carrying bus bars that form a portion of the vehicle electrical system;

FIG. 29 is a perspective view of a second pair of sleeves carrying bus bars that form a portion of the vehicle electrical system;

FIG. 30 is a perspective view of a first type of electrical connector that may be utilized by the vehicle electrical system;

FIG. 31 is a perspective view of a second type of electrical connector that may be utilized by the vehicle electrical system;

FIG. 32 is a perspective view of a third type of electrical connector that may be utilized by the vehicle electrical system;

FIG. 33 is a flowchart illustrating a method for installing an upfit package onto the vehicle;

FIG. 34 illustrates an augmented visual utilized by the method in FIG. 33 during installation of the upfit package; and

FIG. 35 illustrates a plurality of accessories that may be attached to a frame rail.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

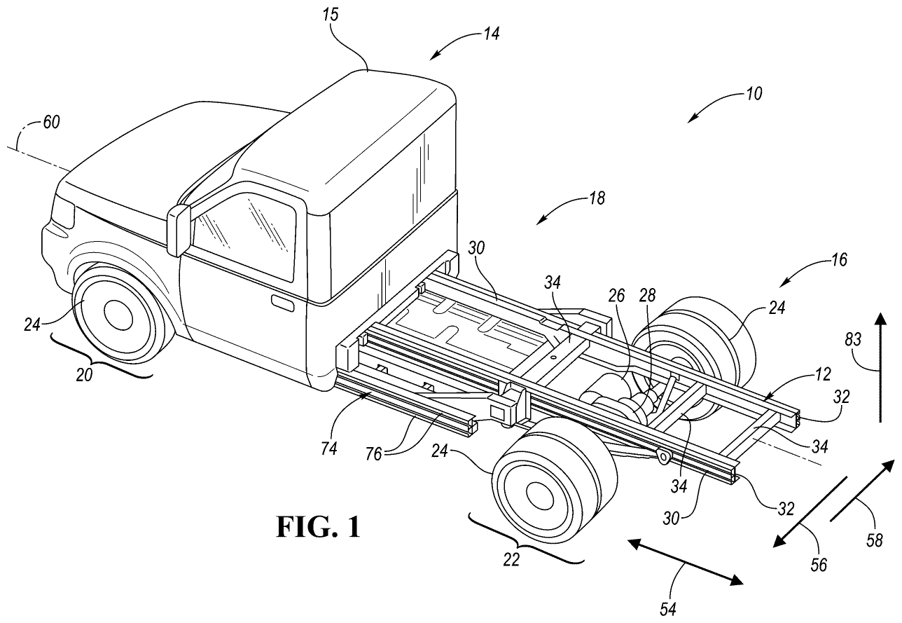

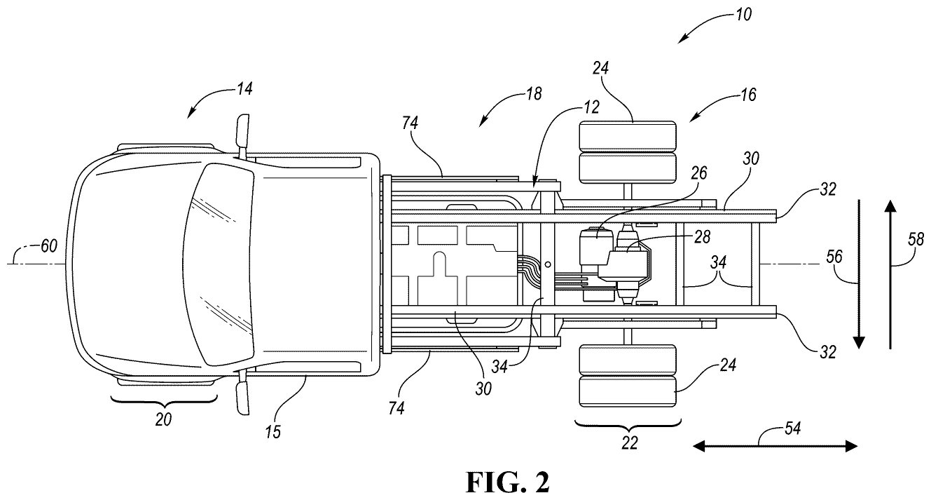

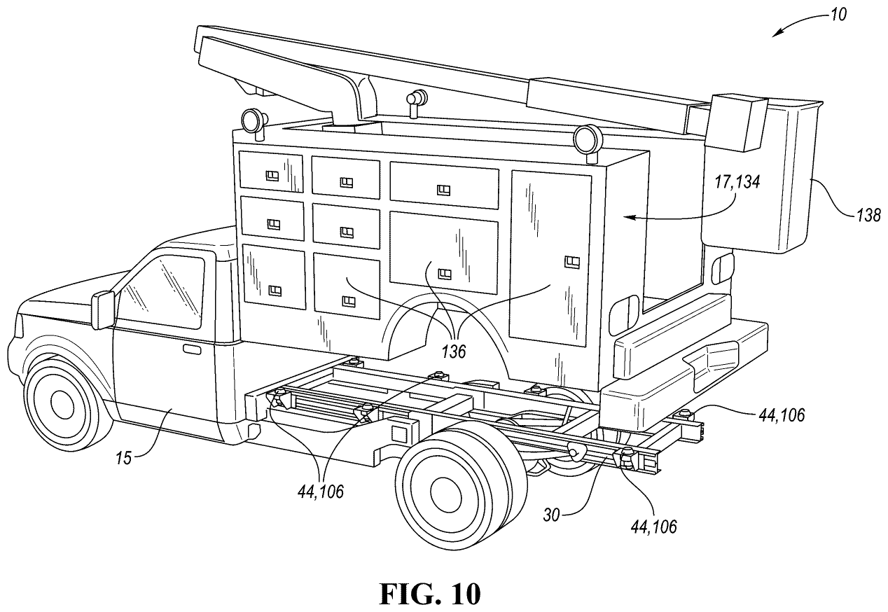

Referring to FIGS. 1-4, a vehicle 10 and a vehicle frame 12 are illustrated. The frame 12 includes a forward region 14, a rearward region 16, and a central region 18. The central region 18 disposed between the forward regions 14 and the rearward region 16. The forward region 14 is configured to receive a cabin section or cabin portion 15 of a vehicle body. The rearward region 16 is configured to receive a plurality of interchangeable rear sections or rear portions 17 of the vehicle body. Examples of interchangeable rear portions 17 of the vehicle body are illustrated in FIGS. 10-12.

The vehicle 10 includes a front or first axle 20 disposed along the forward region 14 of the frame 12. The vehicle 10 includes a rear or second axle 22 spaced-apart from the first axle 20 and disposed along the rearward region 16 of the frame 12. The first axle 20 and the second axle 22 may each be secured to the frame 12. The first axle 20 and the second axle 22 may each include wheels 24. An electric machine 26 (e.g., a motor and/or generator) may be secured to the first axle 20 and/or the second axle 22. The electric machine 26 may be configured to operate as a motor to propel the vehicle or may operate as a generator to store electrical energy in a battery. The second axle 22 may also include a differential 28, which allows the wheels 24 on the opposing sides of the second axle 22 to rotate at different speeds.

The frame 12 includes first and second opposing rails 30 extending from the forward region 14 to the rearward region 16. More specifically, first and second opposing rails 30 may extend from the forward region 14, to the second axle 22, along the rearward region 16, and beyond the second axle 22 to a rear end 32 of the frame 12. The frame 12 also includes cross beams 34 extending between the first and second opposing rails 30.

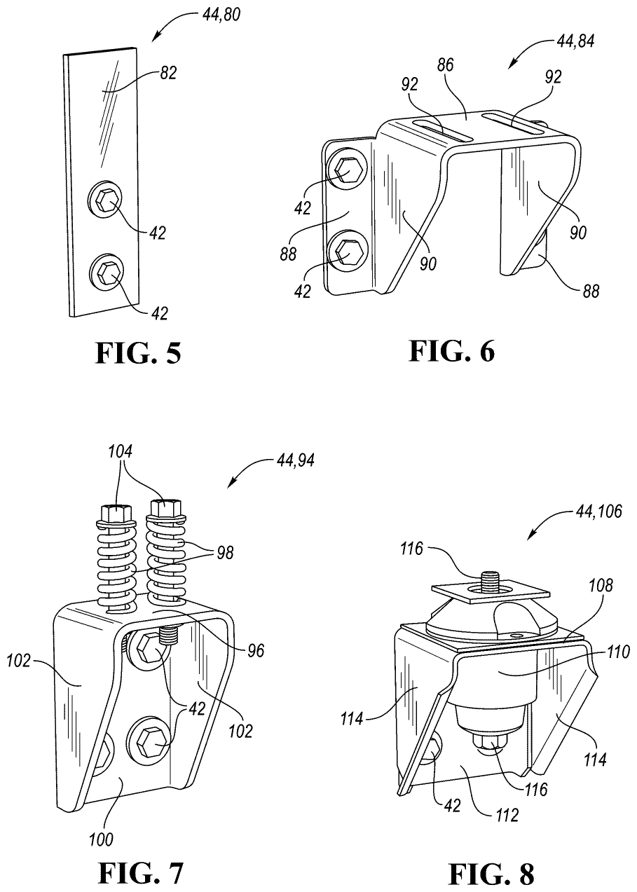

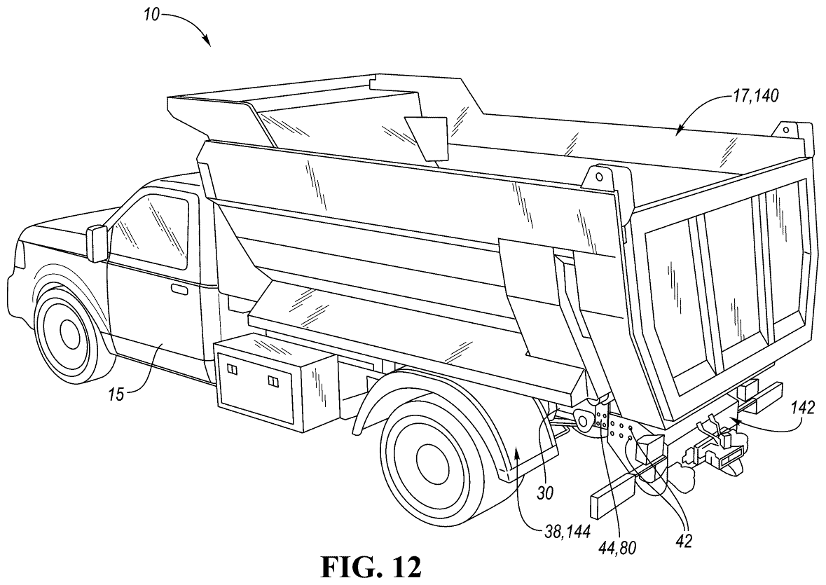

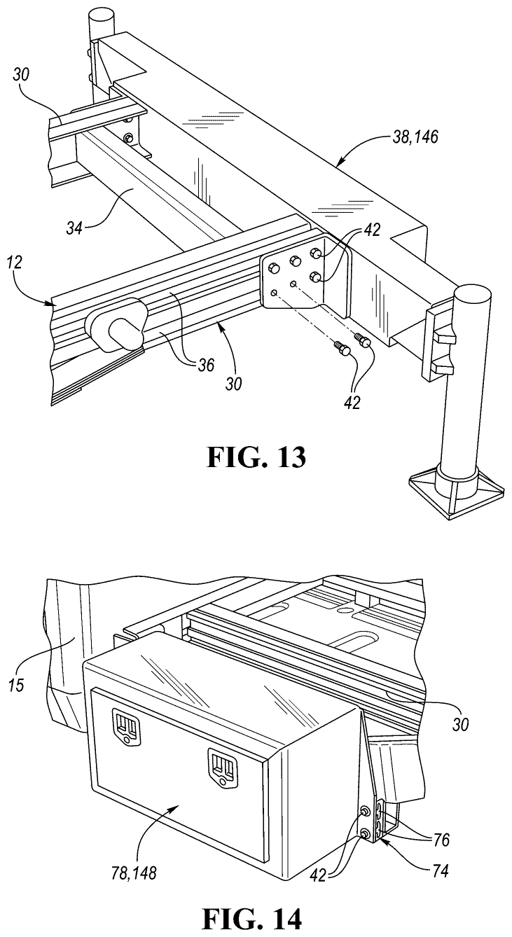

The first and second opposing rails 30 define T-slots 36 configured to receive fasteners for mounting the interchangeable rear portions 17 of the vehicle body, other vehicle subcomponents 38, or other vehicle subsystems to the frame 12. Examples of other vehicle subcomponents 38 are illustrated in FIGS. 12-13. More specifically, the T-slots 36 are configured to T-nuts, anchors nuts, or fastening anchors 40; the fastening anchors 40 are configured to engage the first and second opposing rails 30 within the T-slots 36; and threaded fasteners 42 are configured to engage, the interchangeable rear portions 17 of the vehicle body, other vehicle subcomponents 38, modular components, selectable components, or other vehicle subsystems and the fastening anchors 40 to secure the rear portions 17 of the vehicle body, other vehicle subcomponents 38, modular components, selectable components, or other vehicle subsystems to the first and second opposing rails 30. The rear portions 17 of the vehicle body, other vehicle subcomponents 38, and other vehicle subsystems may be secured to the first and second opposing rails 30 via different or various types of mounting brackets 44, where the threaded fasteners 42 engage the mounting brackets 44. Examples of mounting brackets 44 are illustrated in FIGS. 5-8. The fastening anchors 40 may be referred to as modular vehicle component fastening anchors, vehicle component securing T-nuts, or vehicle component attaching anchor nuts.

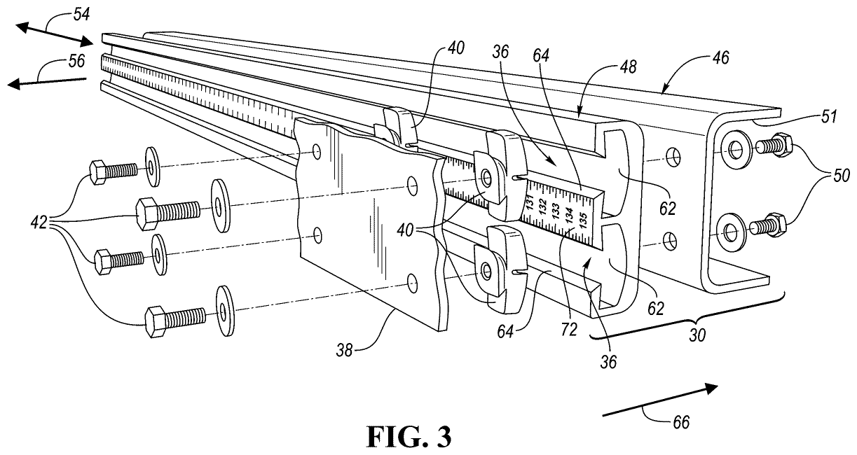

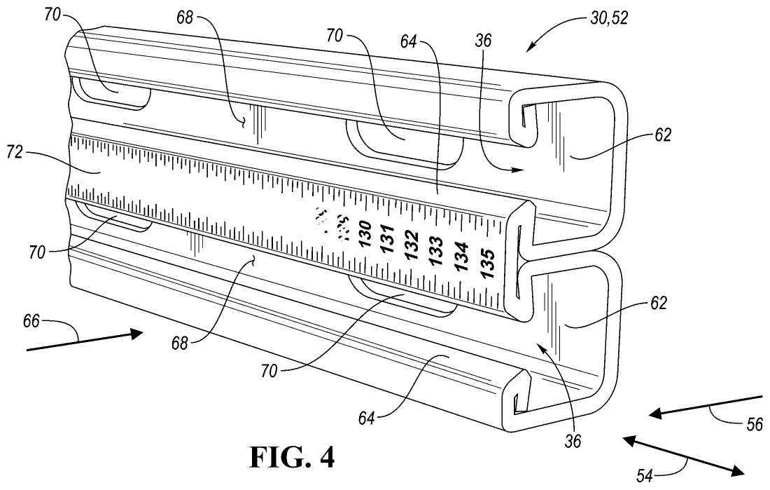

The first and second opposing rails 30 may each include frame rails 46 and fastening rails 48 (e.g., FIG. 3). The fastening rails 48 may define the T-slots 36 and may be secured to the frame rails 46 via fasteners 50. The frame rails 46 may define C-channels 51 that face an opposing direction relative to the T-slots 36. Alternatively, the frame rails 46 and fastening rails 48 of each of the first and second opposing rails 30 may be formed as a single integrated component 52 (e.g., FIG. 4). For example, a single sheet or bar of material may be formed into the single integrated component 52 depicted in FIG. 4.

The T-slots 36 extend longitudinally between the forward region 14 of the frame 12 and the rearward region 16 of the frame 12. For example, the T-slots 36 extend longitudinally in a direction 54 that extends between the forward region 14 of the frame 12 and the rearward region 16 of the frame 12. The T-slots 36 also face laterally outward from the frame 12. For example, the T-slots 36 face laterally outward from the frame 12 in either direction 56 or direction 58. The direction the T-slot 36 faces laterally outward from (i.e., either direction 56 or direction 58) depends on which side of the vehicle 10 the T-slot is disposed. More specifically, the T-slots 36 are also configured to face outward from a central longitudinal axis 60 of the vehicle 10.

Each of the first and second opposing rails 30 may include a stacked pair of T-slots 36. For example, each of the first and second opposing rails 30 may include two T-slots 36 that are arranged in a column. The T-slots 36 have head regions 62 and neck regions 64. The neck regions 64 taper in a direction 66 extending toward the head regions 62. The head regions 62 are bowed or arced on opposing sides of the head regions 62 relative to the neck regions 64. Internal rear or back surfaces 68 of the first and second opposing rails 30 along the head regions 62 may define cutouts or openings 70 that are in communication with the T-slots 36. Each of the first and second opposing rails 30 may include a ruler or measurement marks 72 to provide for precise positioning of the fastening anchors 40 so that the rear portions 17 of the vehicle body, other vehicle subcomponents 38, other vehicle subsystems, or mounting brackets 44 may be precisely positioned in desired positions along the first and second opposing rails 30 when being secured to the first and second opposing rails 30.

The frame 12 may also includes third and fourth opposing rails 74 disposed along the central region 18 of the frame 12 and laterally outward of the first and second opposing rails 30. The third and fourth opposing rails 74 define additional T-slots 76 configured to receive fasteners (e.g., the fastening anchors 40 are configured to engage the third and fourth opposing rails 74 within the T-slots 76, where the fastening anchors 40 are also configured to engage threaded fasteners 42 to secure the vehicle accessories 78 to the third and fourth opposing rails 74) for mounting vehicle accessories 78 to the frame 12. An example of a vehicle accessory is illustrated in FIG. 14.

Each of the third and fourth opposing rails 74 may include a stacked pair of T-slots 76. For example, each of the third and fourth opposing rails 74 may include two T-slots 76 that are arranged in a column. The T-slots 76 have head regions and neck regions in the same manner as T-slots 36. The neck regions taper in a direction extending toward the head regions of the T-slots 76 in the same manner as T-slots 36. The head regions of the T-slots 76 are bowed or arced on opposing sides of the head regions of the T-slots 76 relative to the neck regions of the T-slots 76 in the same manner as T-slots 36. Each of the third and fourth opposing rails 74 may include a ruler or measurement marks to provide for precise positioning of the fastening anchors 40 so that the vehicle accessories 78 may be precisely positioned in desired positions along third and fourth opposing rails 74 when secured to the third and fourth opposing rails 74.

Referring to FIGS. 5-8, several various types of mounting structures or variations of the mounting brackets 44 are illustrated. A first type of mounting bracket 80 of the various types of mounting brackets 44 is illustrated in FIG. 5. The first type of mounting bracket 80 includes a plate 82 that is configured to engage lateral sides of attachable components (e.g., the interchangeable rear portions 17 of the vehicle body, other vehicle subcomponents 38, other vehicle subsystems, or vehicle accessories 78) when such attachable components are attached to the vehicle frame 12 via the first type of mounting bracket 80.

Threaded fasteners 42 may extend through orifices or slots defined by the plate 82 and engage fastening anchors 40 disposed within the T-slots 36 to secure the first type of mounting bracket 80 to one of the first and second opposing rails 30. Alternatively, the threaded fasteners 42 may extend through the orifices or slots defined by the plate 82 and engage fastening anchors 40 disposed within the T-slots 76 to secure the first type of mounting bracket 80 to one of the third and fourth opposing rails 74. The first type of mounting bracket 80 may prevent or limit lateral movement (e.g., movement in either direction 56 or direction 58) of such attachable components along the vehicle frame 12, but not longitudinal movement (e.g., movement between the front end and rear end of the vehicle 10 along direction 54) of such attachable components along the vehicle frame 12, and not upward or downward movement (e.g., movement up or down along direction 83 in FIG. 1) of such attachable components along the vehicle frame 12. Therefore, the first type of mounting bracket 80 may be referred to as a non-rigid mounting bracket.

A second type of mounting bracket 84 of the various types of mounting brackets 44 is illustrated in FIG. 6. The second type of mounting bracket 84 includes an upper plate 86 that configured to engage lower ends or sides of attachable components (e.g., the interchangeable rear portions 17 of the vehicle body, other vehicle subcomponents 38, other vehicle subsystems, or vehicle accessories 78) when such attachable components are attached to the vehicle frame 12 via the second type of mounting bracket 84. The second type of mounting bracket 84 also includes lateral flanges 88 that extend downward and laterally outward from the upper plate 86 and support plates 90 that extend between the lateral flanges 88 and the upper plate 86. The support plates 90 provide structural stability.

Threaded fasteners 42 may extend through orifices or slots defined by the lateral flanges 88 and engage fastening anchors 40 disposed within the T-slots 36 to secure the second type of mounting bracket 84 to one of the first and second opposing rails 30. Alternatively, the threaded fasteners 42 may extend through the orifices or slots defined by the lateral flanges 88 and engage fastening anchors 40 disposed within the T-slots 76 to secure the second type of mounting bracket 84 to one of the third and fourth opposing rails 74.

The second type of mounting bracket 84 may define slots 92 and protrusion, pins, or other elements may extend downward from the attachable components and into the slots 92. Engagement between such protrusions, pins, or other elements and the slots 92 may prevent or limit lateral movement (e.g., movement in either direction 56 or direction 58) of such attachable components along the vehicle frame 12 to first value. Such a first value may correspond to lengths of the slots 92 minus a dimension, such as a diameter, of the protrusions, pins, or other elements that extend downward from the attachable components. Engagement between such protrusions, pins, or other elements and the slots 92 may prevent or limit longitudinal movement (e.g., movement between the front end and rear end of the vehicle 10 along direction 54) of such attachable components along the vehicle frame 12 to second value. Such a second value may corresponding to widths of the slots 92 minus a dimension, such as a diameter, of the protrusions, pins, or other elements that extend downward from the attachable components. Engagement between such protrusions, pins, or other elements and the slots 92 may not prevent or limit not upward movement (e.g., upward movement along direction 83 in FIG. 1) of such attachable components along the vehicle frame 12. Therefore, the second type of mounting bracket 84 may be referred to as a non-rigid mounting bracket.

A third type of mounting bracket 94 of the various types of mounting brackets 44 is illustrated in FIG. 7. The third type of mounting bracket 94 includes an upper plate 96. Springs 98 are positioned along the top of the upper plate 96 and are configured to engage lower ends or sides of attachable components (e.g., the interchangeable rear portions 17 of the vehicle body, other vehicle subcomponents 38, other vehicle subsystems, or vehicle accessories 78) when such attachable components are attached to the vehicle frame 12 via the third type of mounting bracket 94. The third type of mounting bracket 94 also includes a back plate 100 that extends downward from the upper plate 96 and support plates 102 that extend between the back plate 100 and the upper plate 96. The support plates 102 provide structural stability.

Threaded fasteners 42 may extend through orifices or slots defined by the back plate 100 and engage fastening anchors 40 disposed within the T-slots 36 to secure third type of mounting bracket 94 to one of the first and second opposing rails 30. Alternatively, the threaded fasteners 42 may extend through the orifices or slots defined by the back plate 100 and engage fastening anchors 40 disposed within the T-slots 76 to secure the third type of mounting bracket 94 to one of the third and fourth opposing rails 74.

Fasteners 104 may attach lower ends or sides of attachable components to the third type of mounting bracket 94. The springs 98 may be disposed about the fasteners 104 and between the upper plate 96 and the attachable components. The fasteners 104 may prevent or limit lateral movement (e.g., movement in either direction 56 or direction 58) of such attachable components along the vehicle frame 12 and prevent or limit longitudinal movement (e.g., movement between the front end and rear end of the vehicle 10 along direction 54) of such attachable components along the vehicle frame 12. The springs 98 may limit upward or downward movement (e.g., movement up or down along direction 83 in FIG. 1) of such attachable components along the vehicle frame 12 to loads the attachable components apply to the springs 98. Therefore, the third type of mounting bracket 94 may be referred to as a semi-rigid mounting bracket.

A fourth type of mounting bracket 106 of the various types of mounting brackets 44 is illustrated in FIG. 8. The fourth type of mounting bracket 106 includes an upper plate 108. A shock absorber 110 is positioned on the upper plate 108 and is configured to engage lower ends or sides of attachable components (e.g., the interchangeable rear portions 17 of the vehicle body, other vehicle subcomponents 38, other vehicle subsystems, or vehicle accessories 78) when such attachable components are attached to the vehicle frame 12 via the fourth type of mounting bracket 106. The fourth type of mounting bracket 106 also includes a back plate 112 that extends downward from the upper plate 108 and support plates 114 that extend between the back plate 112 and the upper plate 108. The support plates 114 provide structural stability.

Threaded fasteners 42 may extend through orifices or slots defined by the back plate 112 and engage fastening anchors 40 disposed within the T-slots 36 to secure fourth type of mounting bracket 106 to one of the first and second opposing rails 30. Alternatively, the threaded fasteners 42 may extend through the orifices or slots defined by the back plate 112 and engage fastening anchors 40 disposed within the T-slots 76 to secure the fourth type of mounting bracket 106 to one of the third and fourth opposing rails 74.

A fastener 116 may extend through the shock absorber 110 and engage lower ends or sides of the attachable components to attach the attachable components to the fourth type of mounting bracket 106. The fastener 116 may prevent or limit lateral movement (e.g., movement in either direction 56 or direction 58) of such attachable components along the vehicle frame 12 and prevent or limit longitudinal movement (e.g., movement between the front end and rear end of the vehicle 10 along direction 54) of such attachable components along the vehicle frame 12. The shock absorber 110 may limit upward or downward movement (e.g., movement up or down along direction 83 in FIG. 1) of such attachable components along the vehicle frame 12 to loads the attachable components apply to shock the absorber 110. Therefore, the fourth type of mounting bracket 106 may be referred to as a semi-rigid mounting bracket.

A rigid configuration may correspond to the attachable components (e.g., the interchangeable rear portions 17 of the vehicle body, other vehicle subcomponents 38, other vehicle subsystems, or vehicle accessories 78) being secured to the vehicle frame 12 such that lateral movement (e.g., movement in either direction 56 or direction 58), longitudinal movement (e.g., movement between the front end and rear end of the vehicle 10 along direction 54), and upward or downward movement (e.g., movement up or down along direction 83 in FIG. 1) of such attachable components relative to the vehicle frame 12 is prevented or restricted. In such a rigid configuration, the attachable components may be directed secured to the frame 12 (e.g., one of the first and second opposing rails 30 or one of the third and fourth opposing rails 74) or may be secured to the frame 12 via an additional bracket that restricts movement the attachable components relative to vehicle frame 12 in all directions.

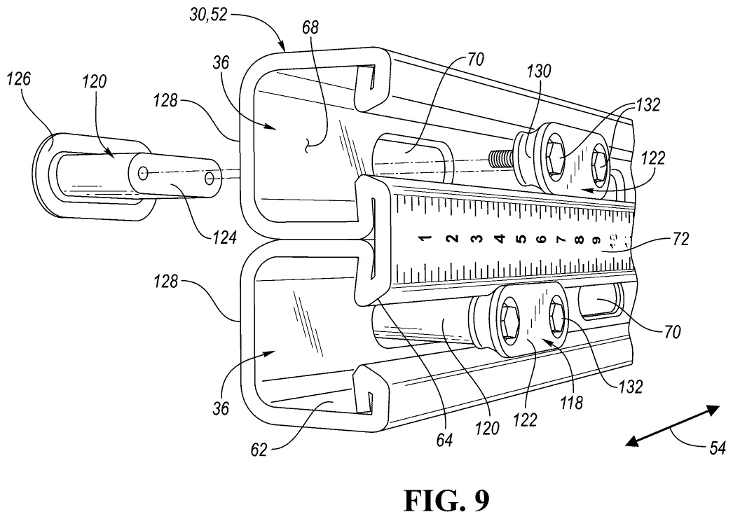

Referring to FIG. 9, one of the opposing rails 30 that is formed as a single integrated component 52 is illustrated in conjunction with stops, stoppers, or stop pins 118. A first stop pin 118 is illustrated in an exploded arrangement while a second stop pin 118 is illustrated in engagement with the rail 30. Each of the stop pins 118 is configured to be disposed within one of the openings 70 defined by back surfaces 68.

The stop pins 118 extend into the T-slots 36 and are configured to engage the fasteners (e.g., the fastening anchors 40 and/or the threaded fasteners 42 that are in engagement with one of the interchangeable rear portions 17 of the vehicle body, other vehicle subcomponents 38, other vehicle subsystems, vehicle accessories 78, or a corresponding mounting bracket 44) within the T-slots 36 to restricted movement of the corresponding interchangeable rear portion 17 of the vehicle body, other vehicle subcomponent 38, other vehicle subsystem, vehicle accessory 78, or corresponding mounting bracket 44 that is secured to the fasteners in a direction between the forward and rearward regions of the frame (e.g., along direction 54).

The stop pins 118 each include a first portion 120 and a second portion 122. The first portion 120 includes a projection 124 and a flange 126. The projection 124 is sized to extend through the openings 70 and into the T-slots 36. The flange 126 is sized to be larger than the openings 70 and is configured to engage a rear surface 128 of the rail 30 to limit movement of the first portion 120 into the T-slot 36. The second portion 122 is tapered along a peripheral edge 130 and is configured to engage the rail 30 along the neck region 64 of the T-slots 36 to limit movement of the second portion 122 into the T-slots 36. The first portion 120 is secured to the second portion 122 via fasteners 132 that extend through through-holes defined by the second portion 122 and engage threaded holes defined by the first portion 120. Alternatively, the first portion 120 may define the through holes, while the second portion 122 defines threaded holes. Securing the first portion 120 to the second portion 122 while the first portion is in one of the openings also affixes the stop pin 118 to the rail 30. Furthermore, the fasteners 132 may pull the first portion 120 second portion 122 toward each other and into engagement such that the stop pin 118 applies a compression force to the rail 30. For example, engagement of the flange 126 on the rear surface 128 of the rail 30 and engagement of the peripheral edge 130 on the rail 30 within the neck region 64 are in opposing directions such that the stop pin 118 generates a compression force on the rail 30 that increases as the fasteners 132 are tightened.

Referring to FIG. 10, the vehicle 10 is illustrated in a first upfit configuration. In the first upfit configuration, the interchangeable rear portion 17 of the vehicle body that is secured to the frame 12 is a service body 134. The service body 134 may be secured the first and second opposing rails 30 via a plurality of brackets (e.g., a plurality of the fourth type of mounting brackets 106) that are secured to the first and second opposing rails 30 via the fastening anchors 40 and the threaded fasteners 42 as described above. The service body may include a plurality of storage containers 136 and a cherry picker 138.

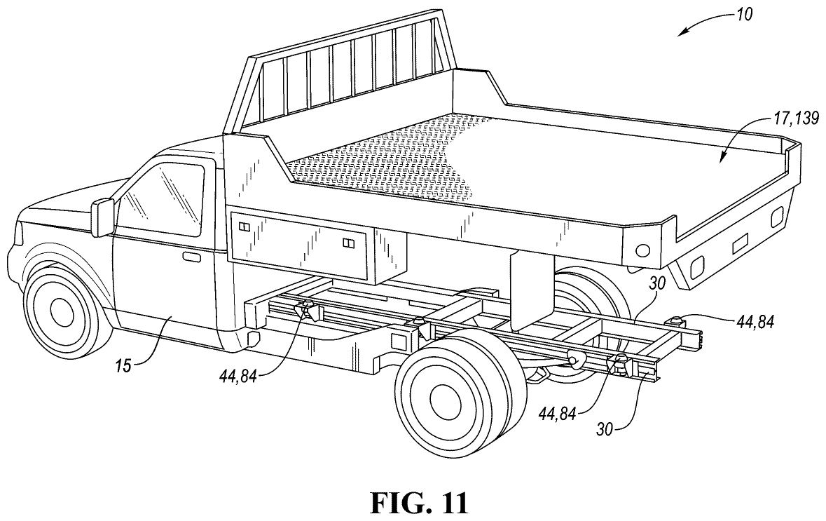

Referring to FIG. 11, the vehicle 10 is illustrated in a second upfit configuration. In the second upfit configuration, the interchangeable rear portion 17 of the vehicle body that is secured to the frame 12 is a weld body or flatbed 139. The flatbed 139 may be secured the first and second opposing rails 30 via a plurality of brackets (e.g., a plurality of the second type of mounting brackets 84) that are secured to the first and second opposing rails 30 via the fastening anchors 40 and the threaded fasteners 42 as described above.

Referring to FIG. 12, the vehicle 10 is illustrated in a third upfit configuration. In the third upfit configuration, the interchangeable rear portion 17 of the vehicle body that is secured to the frame 12 is a dump box 140. A lift mechanism 142 may be secured to the first and second opposing rails 30 directly in a rigid configuration via the fastening anchors 40 and the threaded fasteners 42 as described above. The dump box 140 in turn may be secured to the lift mechanism 142, which is configured to tilt the dump box 140 to dump the contents out of the dump box 140 via gravity. A plurality of the first type of mounting brackets 80 may be secured to the first and second opposing rails 30 via the fastening anchors 40 and the threaded fasteners 42 on opposing sides of the dump box 140 as described above to prevent or limit lateral movement (e.g., movement in either direction 56 or direction 58) of the dump box 140 relative to the frame 12. Other vehicle subcomponents 38, such as wheel covers 144 defining wheel wells, may also be secured to the first and second opposing rails 30 via the fastening anchors 40 and the threaded fasteners 42.

Referring to FIGS. 13 and 14, other vehicle subcomponents 38 and accessories 78 are illustrated as being secured to frame 12 via the fastening anchors 40 and the threaded fasteners 42. For Example, FIG. 13 illustrates an outrigger 146 that is directly or rigidly secured to the first and second opposing rails 30 via the fastening anchors 40 and the threaded fasteners 42. As another example, FIG. 14 illustrates a storage box 148 that is directly or rigidly secured to the third and fourth opposing rails 74 via the fastening anchors 40 and the threaded fasteners 42.

The system described herein provides the benefit of allowing an end user to select and install a desired upfit package and attached desired components of the upfit package to the first and second opposing rails 30 or to the third and fourth opposing rails 74 (e.g., see FIGS. 11-14) via the fastening anchors 40 and the threaded fasteners 42. This provides for ease of installation and removes the need to alter the vehicle frame 12, which often requires cutting, drilling, or applying some other material removing process to the frame 12, when the installing the desired upfit package.

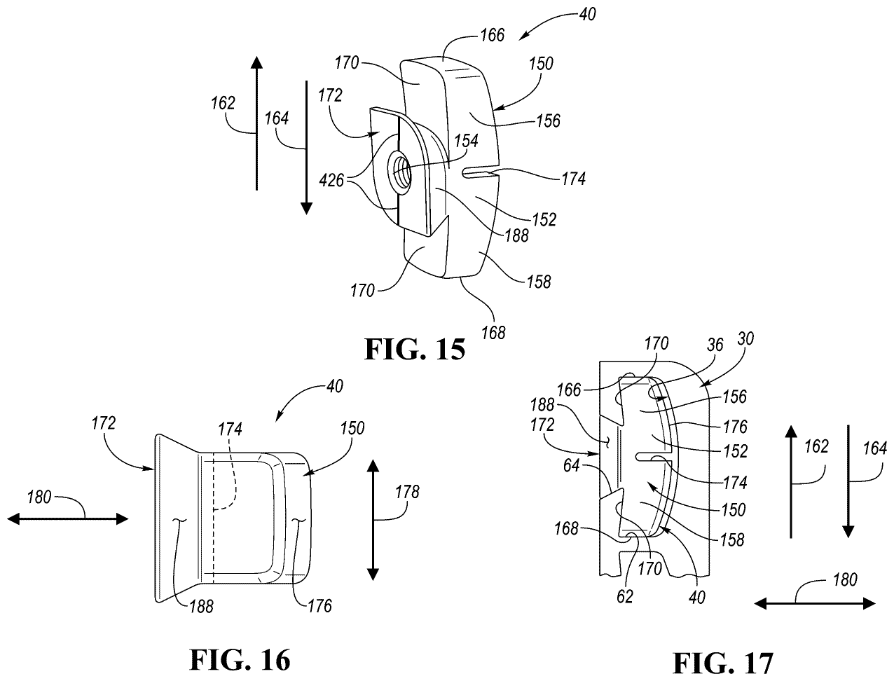

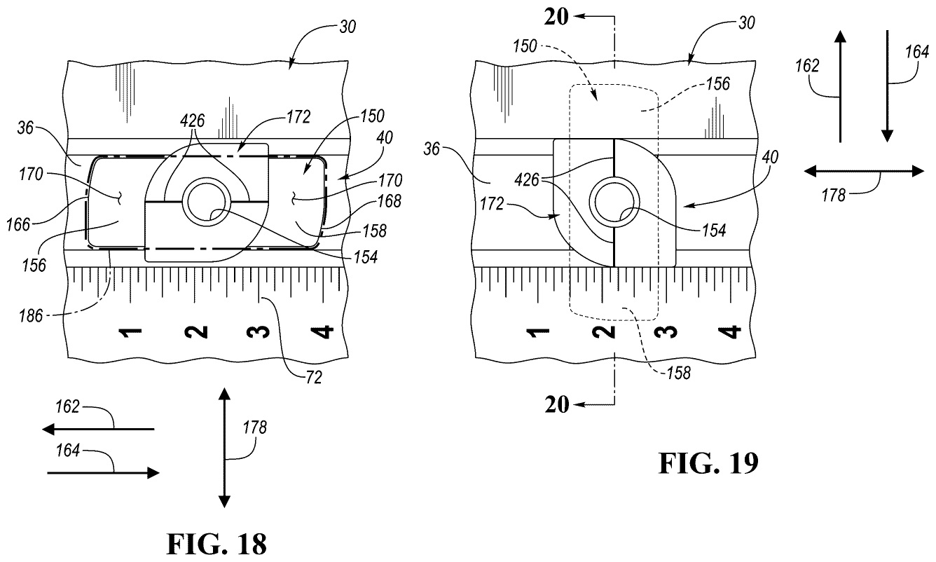

Referring to FIGS. 15-21, one of the fastening anchors 40 is illustrated in further detail, including the engagement between the fastening anchor 40 and a T-slot (e.g., T-slot 36 or T-slot 76) and the engagement between the fastening anchor 40 and the and one of the threaded fasteners 42. It is noted that the engagement between the fastening anchor 40 and the T-slot 36 as illustrated in FIGS. 17-21 may also be representative of the engagement between the fastening anchor 40 and the T-slot 76.

The fastening anchor 40 includes a head 150 configured to engage a mating component (e.g., first and second opposing rails 30 or third and fourth opposing rails 74) within a first region (e.g., head region 62) of a T-slot (e.g., T-slot 36 or T-slot 76) defined by the mating component. The fastening anchor 40 includes a central region 152 defining an orifice 154 configured to receive a fastener (e.g., fastener 42). The central region 152 may at least in part be a central region of the head 150, and the orifice 154 may be a tapped or threaded orifice configured to receive a threaded fastener.

The fastening anchor 40 may further include a first region 156 and a second region 158 extending in opposing directions (e.g., a first direction 162 and a second direction 164), respectively, from the central region 152 and/or the orifice 154 to a first end 166 and a second end 168 of the fastening anchor 40, respectively. The first end 166 and second end 168 may be referred to as distal ends of the first region 156 and the second region 158, respectively. The first region 156 and the second region 158 may be protrusions, flanges, or flanged regions that form a portion of the head 150 and extend in opposite directions from the central region 152 and/or the orifice 154. The first end 166 and the second end 168 of the fastening anchor 40 may correspond to first and second opposing longitudinal end surfaces, respectively, of the head 150. The first region 156 and the second region 158 may be biased inward toward the orifice 154 (e.g., radially inward toward a central axis 160 of the orifice 154). Stated in other terms, the first region 156 and the second region 158 may extend into the orifice 154 such that the orifice 154 is tapered when the threaded fastener 42 is not engaging the orifice 154.

The fastening anchor 40, or more specifically the head 150, has one or more base surfaces 170 positioned along the first region 156 and the second region 158. The one or more base surfaces 170 may be oriented transversely to the first end 166 and the second end 168. If the one or more base surfaces 170 includes more than one surface, such surfaces comprising the one or more base surfaces 170 may be oriented along a common plane, and such a common plane may be curved.

The fastening anchor 40 may also include a shank or neck 172. The neck 172 is configured to engage the mating component (e.g., first and second opposing rails 30 or third and fourth opposing rails 74) within a second region (e.g., neck region 64) of the T-slot (e.g., T-slot 36 or T-slot 76) defined by the mating component. The neck 172 protrudes from the one or more base surfaces 170 along the central region 152. The neck 172 may partially define the orifice 154 along with the head 150 along the central region 152.

The first region 156 and the second region 158 are configured to extend away, extend outward from, or shift outward from the orifice 154 (e.g., radially outward from the central axis 160 of the orifice 154) in response to the threaded fastener 42 engaging the orifice 154 such that the first region 156 and the second region 158, or more specifically the first end 166 and second end 168, engage the mating component within the corresponding T-slot (e.g., T-slot 36 or T-slot 76). More specifically, the first end 166 and the second end 168 may engage the mating component along opposing ends of the first region (e.g., the head region 62) of the T-slot. The first region 156 and the second region 158 are also configured to extend away, extend outward from, or shift outward from the orifice 154 in response to the threaded fastener 42 engaging the orifice 154 such that lower regions (e.g., the one or more base surfaces 170) of the first region 156 and the second region 158 engage the mating component within the first region (e.g., the head region 62) of the T-slot transversely to the first end 166 and the second end 168 and transversely to the opposing ends of the first region of the T-slot.

The central region 152 may define a notch 174. The notch 174 extends inward from an external surface 176 of the fastening anchor 40 that is opposite to the one or more base surfaces 170 along direction 180. The notch 174 may end or terminate at position along the central region 152 in direction 180 that is between the one or more base surfaces 170 and the external surface 176. The notch 174 may also extend through the fastening anchor 40, or more specifically, the head 150 in direction 178. Direction 178 may be orthogonal to or transverse to the direction that extends between the first end 166 and second end 168 (e.g., first direction 162 and second direction 90). Direction 178 may also be orthogonal to or transverse to direction 180. Direction 180 may also be orthogonal to or transverse to the direction that extends between the first end 166 and second end 168 (e.g., first direction 162 and second direction 164). The notch 174 intersects the orifice 154 and is configured to facilitate movement of the first region 156 and the second region 158 inward and outward from the orifice 154 (e.g., radially inward toward or radially outward from the central axis 160 of the orifice 154).

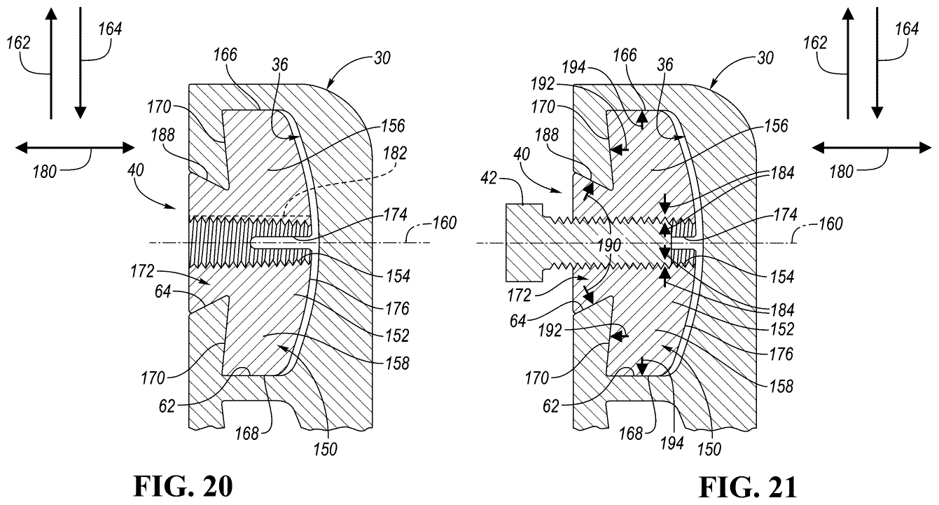

The orifice 154 tapers along the central axis 160 in a direction (e.g., direction 180) that extends from the neck 172 toward the head 150. The taper is configured to decrease in response to the threaded fastener 42 engaging the orifice 154. The taper is illustrated by dotted lines 182 in FIG. 20. Since the first region 156 and the second region 158 may be biased inward toward the orifice 154, the first region 156 and the second region 158 apply a compression force to the threaded fastener 42 when the threaded fastener 42 is in engagement with the fastening anchor 40. The compression force may operate to maintain engagement between the threaded fastener 42 and the orifice 154. For example, the threaded fastener 42 is less likely to work its way out of the orifice due to vibrations or other stimuli. The compression force applied by the first region 156 and the second region 158, and the corresponding reaction force of the threaded fastener 42 are illustrated by arrows 184 in FIG. 21.

The head 150 defines a footprint 186 that is orthogonal to or transverse to the central axis 160 of the orifice 154. The neck 172 is confined to the footprint 186 along the direction that extends between the first end 166 and second end 168 (e.g., a first direction 162 and a second direction 164). The neck extends beyond the footprint 186 along a direction (e.g., direction 178) that is orthogonal to or transverse to the direction that extends between the first end 166 and second end 168.

A peripheral surface 188 of the neck 172 flares radially outward relative to the central axis 160 of the orifice 154 in a direction (e.g., along direction 180) extending away from the head 150. More specifically, the neck 172 is configured to flare radially outward so that the peripheral surface 188 matches the taper of neck region 64 of the T-slots, which facilitates further contact between the fastening anchor 40 and the mating component with the corresponding T-slot (e.g., T-slot 36 or T-slot 76) defined by the mating component. The peripheral surface 188 is configured to engage the mating component within the second region (e.g., the neck region 64) of the T-slot such that the engagement between the peripheral surface 188 and the mating component opposes the engagement between the one or more base surfaces 170 and the mating component.

Contact between the peripheral surface 188 and the mating component, and a corresponding force applied by the peripheral surface 188 to the mating component are illustrated by arrows 190 in FIG. 21. Contact between the one or more base surfaces 170 and the mating component, and a corresponding force applied by the one or more base surfaces 170 to the mating component are illustrated by arrows 192 in FIG. 21. Contact between the first end 166 and second end 168 and the mating component, and a corresponding force applied by first end 166 and second end 168 to the mating component are illustrated by arrows 194 in FIG. 21. The forces between the fastening anchor 40 and the mating component, illustrated by arrows 190, 192, and 194, increase as the threaded fastener 42 engages the orifice 154 pushing the first region 156 and the second region 158 further away from the orifice 154 and into increasing compression along the first end 166, the second end 168, the one or more base surfaces 170, and the peripheral surface 188. Such increasing compression facilitates fixing the position of the fastening anchor 40 and operates to prevent the fastening anchor 40 from moving out of a desired position. Furthermore, the contact between the fastening anchor 40 and the mating component occurs along at least six planes (e.g., planes of contact where the forces illustrated by the arrows 190, 192, and 194 are applied), which further operates to prevent the fastening anchor 40 from moving out of a desired position.

The anchors 40 are design to expand outward in directions along arrows 184, 190, 192, and 194 when fasteners 42 are driven into the tapped orifices 154. The Expansion of the anchors 40 creates pressure against surfaces of the rails 30 along the head region 62 and neck region 64 within the T-slot 36. The expansion of the anchors 40 also creates pressure against the surfaces of the rails 30 within the T-slot 36 opposing the base surfaces 170. These pressures will effectively wedge the anchors securely in place within the T-slot 36 preventing the anchors 40 from moving in longitudinal directions (e.g., movement between the front and rear ends of the vehicle 10 along direction 54).

An upper region or surface of the fastening anchor 40, which may correspond to the external surface 176 of the fastening anchor 40, and which is also opposite to the lower regions or to the one or more base surfaces 170, is convex or dome-shape to facilitate distribution of applied force. More specifically, the dome-shape may operate to more evenly distribute an applied force to all areas of the fastening anchor 40, which operates to protect the structural integrity of the fastening anchor 40. The upper region or surface of the fastening anchor 40 may also correspond to upper regions of the first region 156 and the second region 158.

The one or more base surfaces 170 are concave or angled toward the neck 172 in the opposing directions (e.g., first direction 162 and second direction 164) from the central region 152 to the first end 166 and second end 168. The one or more base surfaces 170 are configured to engage the mating component within the first region (e.g., head region 62) of the T-slot (e.g., T-slot 36 or T-slot 76) to limit rotational movement of the fastening anchor 40 within the T-slot. More specifically, the contact between the one or more base surfaces 170 and the mating component, and the corresponding force 192 applied by the one or more base surfaces 170 to the mating component operates to limit rotational movement of the fastening anchor 40 within the T-slot.

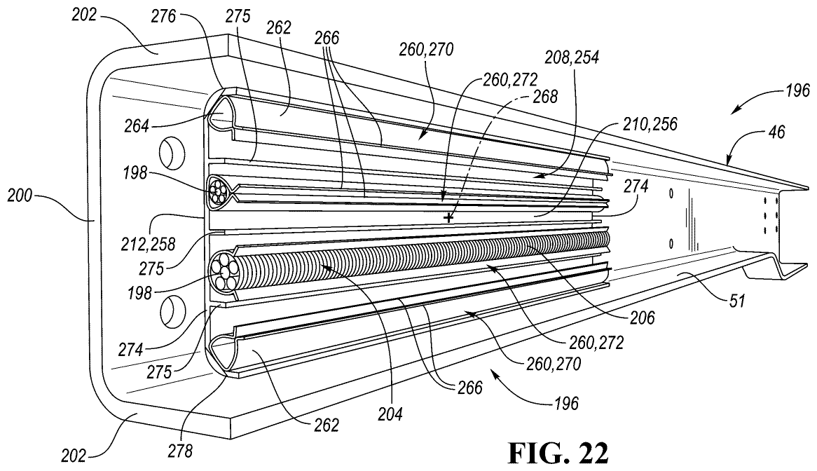

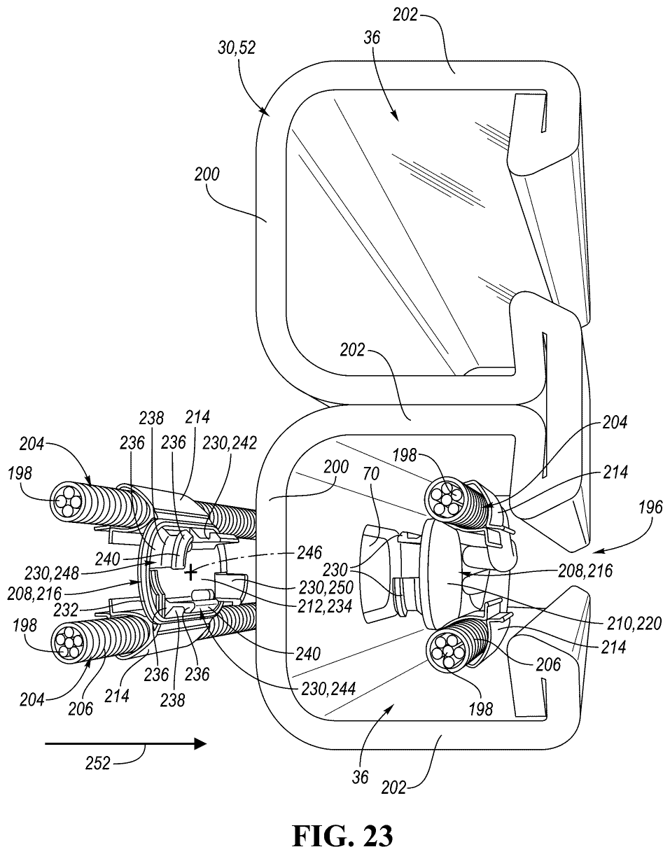

Referring FIGS. 22 and 23, one of the rails 30 formed as a single integrated component 52 and one of the frame rails 46 that forms a portion of one of the rails 30 are illustrated, respectively, in conjunction with a wire system, wire fixation system, or wire harness system 196. The wire harness system 196 is configured to secure wires 198 to the vehicle frame 12, and more specifically to the rails 30. The wire harness system 196 is configured to route electrical wires along the frame 12, and more specifically along the rails 30. The rails 30 may comprise the single integrated components 52 and or the combined structures that include the frame rails 46 and the fastening rails 48. The rails 30 extending longitudinally or lengthwise between the forward region 14 and the rearward region 16 of the frame 12. The rails 30, or more specifically the single integrated components 52 or the frame rails 46, each have at least one web 200 and at least one flange 202 collectively defining at least one channel (e.g., the T-slots 36 or the C-channels 51). The at least one web 200 may define at least one orifice (e.g., openings 70).

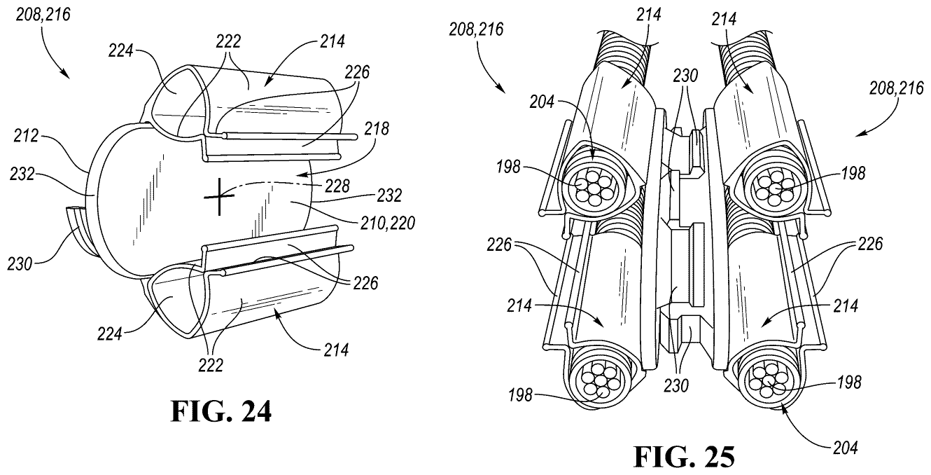

Referring to FIGS. 22-26, the wire harness system 196 is illustrated in further detail. The wire harness system 196 includes one or more the wires 198 or one more bundle 204 of the wires 198. The one or more the wires 198 or one more bundle 204 of the wires 198 extend along one of the rails 30 (e.g., along the one of the single integrated components 52 or one of the frame rails 46). The one or more the wires 198 or one more bundle 204 of the wires 198 may also extend between the forward region 14 and the rearward regions 16 of the frame 12. The one or more the wires 198 or one more bundle 204 of the wires 198 may also extend within a channel (e.g., the T-slots 36 or the C-channels 51) defined by the rail 30. The bundles 204 of the wires 198 may wrapped by an external casing 206, such as a flex tube. The bundles 204 of the wires 198 may have varying sizes. For example, a first of the bundle 204 of wires 198 illustrated in FIG. 22 has a larger diameter than a second of the bundle 204 of wires 198 illustrated in FIG. 22. The external casing 206 may also have varying sizes to correspond with the varying sizes of bundles 204 of the wires 198.

The wire harness system 196 includes brackets 208 that are configured to attach or couple the one or more the wires 198 or one more bundle 204 of the wires 198 to the rail 30 (e.g., to the one of the single integrated components 52 or to one of the frame rails 46). The brackets 208 each a front side 210, a rear side 212, and a plurality of resilient clips 214 extending from the front side 210. Each of the wires 198 or each of the bundle 204 of wires 198 is in engagement or is configured to engage with one of the resilient clips 214. More specifically, the resilient clips 214 operate as clamps that each engage one of the wires 198 or one of the bundles 204 of wires 198 to secure the corresponding wire 198 or bundle 204 of wires 198 to the brackets 208. The rear side 212 of the brackets 208 are in engagement or are configured to engage with the rails 30, or more specifically with the single integrated components 52 or the frame rails 46, to secure the wires 198 or the of the bundles 204 of wires 198 to the rails 30, or more specifically to the single integrated components 52 or to the frame rails 46.

Referring to FIGS. 23-25, a first type of the brackets 208 is illustrated. The first type of the brackets 208 may be referred to as the first bracket 216. The first bracket 216 includes a base plate 218. A plurality of the resilient clips 214 extends from a front side 220 of the base plate 218. The plurality of the resilient clips 214 may be referred as the plurality of the primary resilient clips. Each resilient clip 214 on the first bracket 216 includes opposing sides 222 that are biased inward towards engagement with each other. Each resilient clip 214 receives, engages, is configured to receive, or is configured to engage one of the wires 198 or one of the bundles 204 of wires 198 to secure the one of the wires 198 or the one of the bundles 204 of wires 198 to the base plate 218. Flanges or flared edges 226 may extend outward in different directions from ends of the opposing sides 222 of each resilient clip 214. The flared edges 226 may operate as leads to guide the wires 198 or the bundles 204 of wires 198 into a central space 224 defined by each resilient clip 214 and may also operate to separate the opposing sides 222 of each resilient clip 214 upon engagement with the wires 198 or the bundles 204 of wires 198 so that the wires 198 or the bundles 204 of wires 198 may navigate into the central spaces 224 defined the each resilient clips 214.

Each of the resilient clips 214 may extend away from the front side 220 of the base plate 218 in directions that are angled toward a center of the front side of the first bracket 216, or more specifically toward a center 228 of the front side 220 of the base plate 218. More specifically, regions of the resilient clips 214 that are configured to open to receive the wires 198 or the bundles 204 of wires 198 (e.g., the regions along the flared edges 226) may extend away from the front side 220 of the base plate 218 in directions that are angled toward the center 228 of the front side 220 of the base plate 218. Furthermore, each of the resilient clips 214 within the first bracket 216 may be parallel to each other in a direction extending between lateral edges 232 of the first bracket 216 (e.g., along direction 54 one installed onto a rail 30).

The first bracket 216 also includes a plurality of secondary resilient clips or a plurality of snaps 230 extending from a rear side 234 of the base plate 218. Each snap 230 engages or is configured to engage an orifice (e.g., openings 70) defined by the rail 30 to secure the base plate 218 to the rail, and to secure the first bracket 216 as a whole to the rail 30. More specifically, each snap 230 engages or is configured to selectively engage the rail 30 within a first orifice of a plurality of orifices (e.g., openings 70) defined by the rail 30 to secure the wires 198 of at least one of the bundle of wires 198 to the rail 30, wherein the first bracket 216 is movable between each orifice of the plurality of orifices (e.g., openings 70) to deliver power or data to one or more modular components or selectable components that are securable to and movable along the rail 30. The snaps may be “J-shaped” or may be J-hooks. The snaps 230 are configured flex inward during installation and snap back into original positions to secure the first bracket 216 to the rail. Each snap 230 includes two projections, protrusions, or raised regions 236 and defines valleys or recessed regions 238 between the raised regions. A first of the raised regions 236 of each snap 230 includes an angled or leading edge 240. A first of the raised regions 236 may be an end or tip of each snap 230 while a second of the raised regions 236 may be a base of each snap 230.

The first bracket 216 may be disposed within or may be configured to be disposed within a first channel of the at least one channel (e.g., the T-slots 36 or the C-channels 51). Alternatively, the first bracket 216 may be disposed on an opposing side of a web 200 relative to the first channel of the at least one channel. The rear side 212 of the first bracket 216, or more specifically rear side 234 of the base plate 218, engages a first web of the at least one web 200.

Upon engagement between the leading edges 240 of the snaps 230 and the rail 30 along a periphery of an orifice (e.g., one of the openings 70) during installation of the first bracket 216 (e.g., as the snaps 230 are being pushed into one of the openings 70), the snaps 230 are forced inward from original positions to distorted positions. Once the installed (e.g., once the snaps 230 are completely pushed into one of the openings 70), the snaps 230 spring-back to the original positions (e.g., the snaps 230 shift outward to the original non-distorted position from the distorted position) such that the two raised regions 236 of each snap 230 are disposed on opposing sides of the web 200 and such that portions of the rail 30 along a periphery of the orifice (e.g., one of the openings 70) are disposed and trapped within the recessed regions 238 of the snaps 230, thus securing the first bracket 216 to the rails.

Each of the clips or snaps 230 may include first clip or snap 242 and a second clip or snap 244 disposed along an upper region and a lower region of the base plate 218, respectively. The first snap 242 and the second snap 244 may be offset in opposing directions and/or horizontally from a center 246 of the base plate 218. The center 246 may more specifically be the center of the rear side 234 of the base plate 218. Each of the snaps 230 may also include a third clip or snap 248 and a fourth clip or snap 250 disposed along opposing lateral regions of the base plate 218 respectively. The third snap 248 and the fourth snap 250 may be offset in opposing directions and/or vertically from the center 246 of the base plate 218. The first snap 242, the second snap 244, the third snap 248, and the fourth snap 250 may all extend axially away from the rear side 234 of the base plate 218 in a direction 252. The third snap 248 and the fourth snap 250 may also extend radially along an arc and along a plane that is orthogonal to or transvers to direction 252.

The snaps 230 on each first bracket 216 are spaced-apart and provide clearance so that two of the first brackets 216 may be positioned back-to-back as illustrated in FIG. 8. This also allows two of the first brackets 216 to engage the rail 30 within the same orifice (e.g., one of the openings 70) on opposing sides of the orifice (e.g., on opposing sides of the web 200).

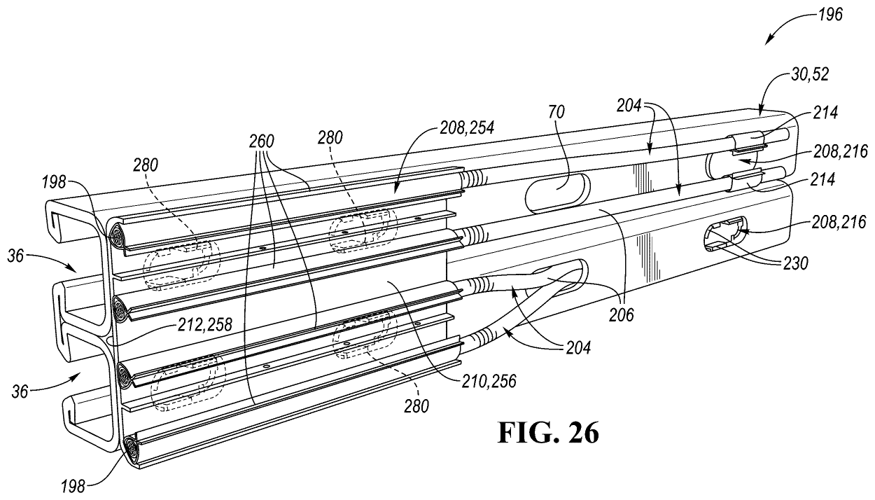

Referring to FIGS. 22 and 26, a second type of the brackets 208 is illustrated. The second type of the brackets 208 may be referred to as the second bracket 254. The second bracket 254 has opposing sides, which may be referred to as the front or first side 256 and the rear or second side 258. The second bracket 254 has a plurality of resilient clips 260 extending from the first side 256.

Each resilient clip 260 on the second bracket 254 includes opposing sides 262 that are biased inward towards engagement with each other. Each of the resilient clips 260 receives, engages, is configured to receive, or is configured to engage one of the wires 198 or one of the bundles 204 of wires 198 to secure the one of the wires 198 or the one of the bundles 204 of wires 198 to the second bracket 254. Flanges or flared edges 266 may extend outward in different directions from ends of the opposing sides 262 of each resilient clip 260. The flared edges 266 may operate as leads to guide the wires 198 or the bundles 204 of wires 198 into the central space 264 defined by each resilient clip 260 and may also operate to separate the opposing sides 262 of each resilient clip 260 upon engagement with the wires 198 or the bundles 204 of wires 198 so that the wires 198 or the bundles 204 of wires 198 may navigate into the central spaces 264 defined the each resilient clips 260.

One or more of the resilient clips 260 may extend away from the front side 256 of the second bracket 254 in directions that are angled toward a center 268 of the front side 256 of the second bracket 254. More specifically, regions of the resilient clips 260 that are configured to open to receive the wires 198 or the bundles 204 of wires 198 (e.g., the regions along the flared edges 266) may extend away from front side 256 of the second bracket 254 in directions that are angled toward the center 268 of the front side 256 of the second bracket 254. The one or more resilient clips 260 that extend away from the front side 256 of the second bracket 254 in directions that are angled toward a center 268 of the front side 256 of the second bracket 254 may form a first set 270 of the resilient clips 260.

One or more of the resilient clips 260 may extend away from the front side 256 of the second bracket 254 in a direction that is orthogonal to the front side 256 of the second bracket 254. More specifically, the regions of the resilient clips 260 that are configured to open to receive the wires 198 or the bundles 204 of wires 198 (e.g., the regions along the flared edges 266) may extend away from front side 256 of the second bracket 254 in the direction that is orthogonal to the front side 256 of the second bracket 254. The one or more resilient clips 260 that extend away from the front side 256 of the second bracket 254 in the direction that is orthogonal to the front side 256 of the second bracket 254 may form a second set 272 of the resilient clips 260. Furthermore, each of the resilient clips 260 within the second bracket 254 may be parallel to each other in a direction extending between lateral edges 274 of the second bracket 254 (e.g., along direction 54 one installed onto a rail 30). Separator walls 275 may be disposed between adjacent clips 260. The separator walls 275 may engage the clips 260 when the clips 260 are being opened to limit an extent or an amount at which the clips 260 may be opened.

The second side 258 of the second bracket 254, an upper surface or upper end 276 of the second bracket 254, and a lower surface or lower end 278 of the second bracket 254 are configured to selectively engage the rail 30 within a channel (e.g., are configured to engage the frame rails 46 within the C-channels 51) to secure the second bracket 254 and the wires 198 or the bundles 204 of wires 198 to the rail 30, wherein the second bracket 254 is movable along the rail 30 to deliver power or data to one or more modular components that are securable to and movable along the rail 30. The upper end 276 and lower end 278 of the second bracket 254 face opposing directions and may each be orthogonal to the first side 256 and the second side 258 of the second bracket 254.

Alternatively, snaps 280 may extend from the second side 258 of the second bracket 254, where the snaps 280 are configured to selectively engage a first orifice of a plurality of orifices (e.g., openings 70) defined by the rail 30 to secure the second bracket 254 to the rail 30, and to secure the wires 198 of at least one of the bundle of wires 198 to the rail 30, wherein the second bracket 254 is movable between each orifice of the plurality of orifices (e.g., openings 70) to deliver power or data to one or more modular components or selectable components that are securable to and movable along the rail 30. The snaps 280 may have the same configuration and may operate in the same manner as snaps 230. Therefore, snaps 280 should be construed to have the same configuration, functionality, subcomponents, etc. as snaps 230.

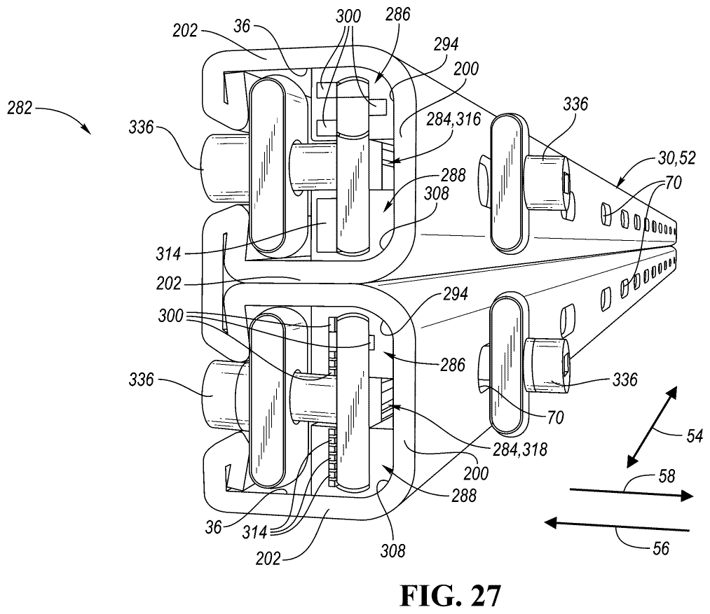

Referring to FIGS. 27-29, an electrical system 282 of the vehicle 10 that is operable to engage the frame 12 of the vehicle 10 is illustrated. More specifically, the electrical system 282 may be mechanically connected or secured to at least one of the rails 30 (e.g., the single integrated component 52) of the frame 12.

The electrical system 282 includes one or more pair of sleeves 284. Each pair of sleeves 284 includes a first sleeve 286 and a second sleeve 288. Each first sleeve 286 extends longitudinally between a first end 290 and a second end 292. Each first sleeve 286 may be disposed within a channel defined by the vehicle frame 12, or more specifically a channel defined by one of the rails 30 (e.g., one of the T-slots 36). Even more specially, each first sleeve 286 may be disposed within one of the T-slots 36 along a first side 294 of the head region 62 of the T-slot 36. When disposed within the channel defined by the vehicle frame 12, each first sleeve 286 may extend longitudinally or lengthwise in a first direction (e.g., direction 54) between forward and rearward regions of the vehicle 10, which may correspond to the forward region 14 of the frame 12 and the rearward region 16 of the frame 12.

Each first sleeve 286 defines a first slot 296. The first slot 296 of each first sleeve extends longitudinally between the first end 290 and the second end 292. When disposed within the channel defined by the vehicle frame 12, each first sleeve 286 extends longitudinally or lengthwise in the first direction (e.g., direction 54) between the forward and rearward regions of the vehicle 10, which may correspond to the forward region 14 of the frame 12 and the rearward region 16 of the frame 12. The first slot 296 of each first sleeve 286 is open along a lateral end, lateral side, or an edge 298 of each first sleeve 286. The lateral end, lateral side, or an edge 298 may also be referred to as an open end, open lateral end, open side, open lateral side, or open edge. The edge 298 of each first sleeve 286 may face laterally relative to the first direction (e.g., direction 54). For example, the edge 298 of each first sleeve 286 may be orthogonal or perpendicular to the first direction. At least one first electrical bus or bus bar 300 is disposed within the first slot 296 of each first sleeve 286. Each bus bar 300 extends longitudinally between the first end 290 and the second end 292. Each bus bar 300 is disposed and exposed along an interior surface 302 of the corresponding first sleeve 286 within the corresponding first slot 296. A remainder 303 of each first sleeve 286 that surrounds the at least one first bus bar 300 may be made from an electrically insulating material.

Each second sleeve 288 extends longitudinally between a third end 304 and a second end 306. Each second sleeve 288 may be disposed within a channel defined by the vehicle frame 12, or more specifically a channel defined by one of the rails 30 (e.g., one of the T-slots 36). Even more specially, each second sleeve 288 may be disposed within one of the T-slots 36 along a second side 308 of the head region 62 of the T-slot 36. The first side 294 and the second side 308 of the head region 62 of the T-slot 36 may be disposed on opposing sides of the neck region 64. The second sleeve 288 may be spaced-apart from the first sleeve 286 within the channel (e.g., T-slot 36). When disposed within the channel defined by the vehicle frame 12, each second sleeve 288 may extend longitudinally or lengthwise in the first direction (e.g., direction 54) between forward and rearward regions of the vehicle 10, which may correspond to the forward region 14 of the frame 12 and the rearward region 16 of the frame 12.

Each second sleeve 288 defines a second slot 310. The second slot 310 of each second sleeve 288 extends longitudinally between the third end 304 and the second end 306. When disposed within the channel defined by the vehicle frame 12, each second sleeve 288 extends longitudinally or lengthwise in the first direction (e.g., direction 54) between the forward and rearward regions of the vehicle 10, which may correspond to the forward region 14 of the frame 12 and the rearward region 16 of the frame 12. The second slot 310 of each second sleeve 288 is open along a lateral end, lateral side, or an edge 312 of each second sleeve 288. The lateral end, lateral side, or an edge 312 may also be referred to as an open end, open lateral end, open side, open lateral side, or open edge. The edge 312 of each second sleeve 288 may face laterally relative to the first direction (e.g., direction 54). For example, edge 312 of each second sleeve 288 may be orthogonal or perpendicular to the first direction. The edge 312 of each second sleeve 288 may also face toward the edge 298 of the first sleeve 286. For example, edge 298 may face downward while edge 312 faces upward. At least one second electrical bus or bus bar 314 is disposed within the first second slot 310 of each second sleeve 288. Each bus bar 314 extends longitudinally between the third end 304 and the second end 306. Each bus bar 314 is disposed and exposed along an interior surface 316 of the corresponding second sleeve 288 within the corresponding second slot 310. A remainder 311 of each second sleeve 288 that surrounds the at least one second bus bar 314 may be made from an electrically insulating material. The at least one first bus bar 300 and at least one second bus bar 314 are configured to collectively engage an electrical connector that is disposed within the first slot 296 and the second slot 310.

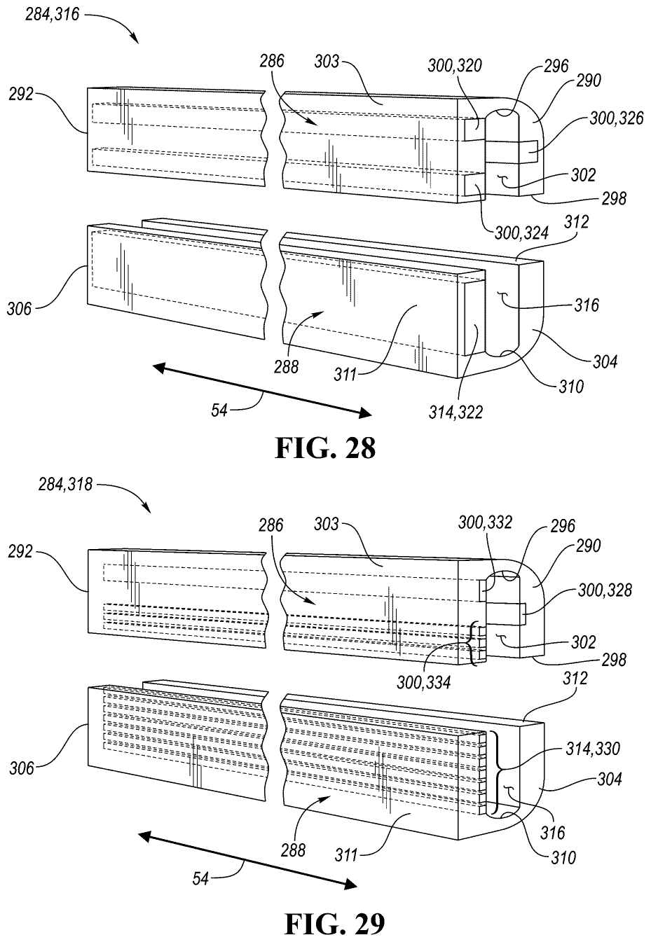

A first arrangement 316 of one of the pairs of sleeves 284 is illustrated in FIGS. 27 and 28, while a second arrangement 318 of one of the pairs of sleeves 284 is illustrated in FIGS. 27 and 29. In the first arrangement 316, a first bus bar 320 of the at least one first bus bar 300 is configured to deliver electrical power at a first output level while a first bus bar 322 of the at least one second bus bar 314 is configured to deliver electrical power at a second output level that is greater than the first output level. For example, the first bus bar 320 of the at least one first bus bar 300 may be configured to deliver electrical power at 12 Volts and 120 Amps, while the first bus bar 322 of the at least one second bus bar 314 may be configured to deliver electrical power at 12 Volts and 250 Amps. Also, the bus bars may be configured to deliver DC or AC power (e.g., three phase AC power) at any desired voltage or amperage. A second bus bar 324 of the at least one first bus bar 300 may also be configured to deliver electrical power at a first output level. A third bus bar 326 of the at least one first bus bar 300 may be a ground connection. Alternatively, the third bus bar 326 that is a ground connection may be relocated from the first sleeve 286 to the second sleeve 288 to a position within the second slot 310 where it would be considered one of the at least one second bus bars 314.

In the second arrangement 318, a first bus bar 328 of the at least one first bus bar 300 is configured to deliver electrical power at a third output level. The third output level may be less than the first and second power output levels. For example, the first bus bar 328 may be configured to deliver electrical power at 12 Volts and less than 120 Amps. The at least one second bus bar 314 may include a first set of data bus bars or data pins 330 that are configured to transmit data between sensing devices and an electrical processing device or controller. A second bus bar 332 of the at least one first bus bar 300 may be a ground connection. Alternatively, the second bus bar 332 that is a ground connection may be relocated from the first sleeve 286 to the second sleeve 288 at a position within the second slot 310 where it would be considered one of the at least one second bus bars 314. The at least one first bus bar 300 may include a second set of data bus bars or data pins 334 that are configured to transmit data between sensing devices and a vehicle controller.

The controller may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the vehicle 10 or vehicle subsystems. Such a controller may be configured to control the torque, speed, power output of a powerplant (e.g., engine or electric motor) the propels the vehicle 10, shifting within a transmission of the vehicle 10, slowing of the vehicle, automatic vehicle maneuvers based on sensed objects within the proximity of the vehicle 10, control of upfit items (e.g., lifting of the dump box 140, moving cherry picker 138, adjusting the outrigger 146), etc.

Referring to FIGS. 27 and 30-32, electrical connectors 336 that are configured to engage the pairs of sleeves 284 are illustrated. Each of the electrical connectors 336 have a base 338, electrical contacts 340 disposed on an exterior surface of the base 338, and an electrical socket or electrical plug 344 extending from the base 338. The electrical plug 344 may extend from one side of the base 338 along a center of the base 338. A first region 346 of the base 338 is configured for disposal or is disposed within the first slot 296 of one of the first sleeves 286 such that a first portion of the electrical contacts 340 engages one or more bus bars of the at least one first bus bar 300. A second region 348 of the base 338 is configured for disposal or is disposed within second slot 310 of one of the second sleeves 288 such that a second portion of the electrical contacts 340 engages one or more bus bars of the at least one second bus bar 314. The electrical connectors 336 are movable within one of the first sleeves 286 and one of the second sleeves 288 along the rail 30 to establish an electrical connection and deliver power or data to one or more modular components. The engagement between the electrical contacts 340 and at least one first and second buses (e.g., the at least one first bus bar 300 and at least one second bus bar 314) establishes an electrical connection between at least one first and second buses (e.g., the at least one first bus bar 300 and at least one second bus bar 314) and the electrical plug 344. The electrical plug 344 is configured to receive or engage an electrical connector to establish a connection with another vehicle component or subsystem (e.g., a modular component) to deliver power or data to such a component or subsystem that may securable to and movable along the rail 30. A remainder of each electrical connector 336 (e.g., a portion other than the electrical contacts 340 and additional contacts or pins within the corresponding electrical plug 344) may be made from an electrically insulating material.

The first region 346 and the second region 348 of the base 338 may engage the first slot 296 of one of the first sleeves 286 and the second slot 310 of one of the second sleeves 288, respectively, in a manner similar to the engagement between the fastening anchors 40 and the T-slot 36 described herein. During installing, the base 338 may be sized so that it may fit though the neck region 64 of the T-slots 36 or through the opening 70 defined by the webs 200. Once inserted through the neck region 64 of the T-slots 36 or through one of the openings 70, the base 338 may then be turned to engage one of the first sleeves 286 within the first slot 296 and one of the second sleeves 288 within the second slot 310, which operates to secure the electrical connector 336 into position.

Once the electrical connector 336 is installed, the electrical plug 344 may extend outward from the corresponding channel (e.g., one of the T-slots 36) and through the neck region 64 of the T-slot 36. Alternatively, the electrical plug 344 may extend outward from the corresponding channel (e.g., one of the T-slots 36) and through one of the orifices (e.g., one of the openings 70) defined by the web 200 and away from the web 200 on an opposing side of the web 200 relative to the T-slot 36. In either configuration, the electrical plug 344 will extend in a direction (e.g., either direction 56 or direction 58) that is lateral relative to the first direction (e.g., direction 54). The electrical connector 336 may also include a handle 350 that is operable for engagement by a worker for installing the electrical connector 336. The handle 350 may be positioned along the electrical plug 344 and may be spaced-apart from the base 338. Upon installation in a first configuration, the handle 350 may be disposed within the corresponding channel (e.g., one of the T-slots 36). Upon installation in a second configuration, the handle 350 may be disposed on an opposing side of the web 200 relative to the T-slot 36.

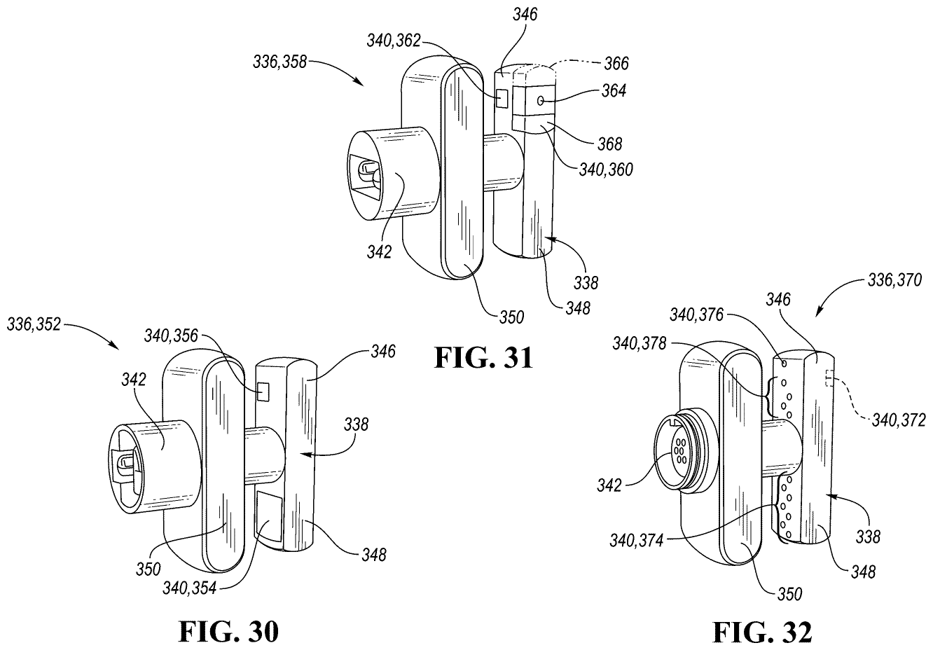

A first configuration 352 of the electrical connectors 336 is depicted in FIG. 30. The first configuration 352 includes a first contact 354 configured to engage the first bus bar 322 of the at least one second bus bar 314 that is configured to deliver electrical power at a second output level and a second contact 356 that is configured to engage the third bus bar 326 of the at least one first bus bar 300 (e.g., the ground connection). The first contact 354 and the second contact 356 establish an electrical connection between the connected bus bars (e.g., the first bus bar 322 of the at least one second bus bar 314 and the third bus bar 326 of the at least one first bus bar 300) and the corresponding electrical plug 344 of the electrical connector 336.

A second configuration 358 the electrical connectors 336 is depicted in FIG. 31. The second configuration 358 includes a first contact 360 configured to engage the first bus bar 320 or the second bus bar 324 of the at least one first bus bar 300 that are each configured to deliver electrical power at a first output level and a second contact 362 that is configured to engage the third bus bar 326 of the at least one first bus bar 300 (e.g., the ground connection). The first contact 360 and the second contact 362 establish an electrical connection between the connected bus bars (e.g., either the first bus bar 320 or the second bus bar 324 of the at least one first bus bar 300 and the third bus bar 326 of the at least one first bus bar 300) and the corresponding electrical plug 344 of the electrical connector 336. The first contact 360 may be configured to pivot along a post 364 between a first position 366 and a second position 368. In the first position 366, the first contact 360 is configured to engage the first bus bar 320 of the at least one first bus bar 300. In the second position 368, the first contact 360 is configured to engage the second bus bar 324 of the at least one first bus bar 300.

A third configuration 370 of the electrical connectors 336 is depicted in FIG. 32. The third configuration 370 includes a first contact 372 configured to engage the first bus bar 328 of the at least one first bus bar 300 that is configured to deliver electrical power at a third output level, a first set of contacts 374 configured to engage the first set of data bus bars or data pins 330 of the at least one second bus bar 314 that are configured to transmit data, a second contact 376 configured to engage the second bus bar 332 of the at least one first bus bar 300 (e.g., the ground connection), and a second set of contacts 378 configured to engage the second set of data bus bars or data pins 334 of the least one at least one first bus bar 300 that are configured to transmit data. The first contact 372, first set of contacts 374, second contact 376, and second set of contacts 378 establish an electrical connection between the connected bus bars (e.g., the first bus bar 328 of the at least one first bus bar 300, the first set of data bus bars or data pins 330 of the at least one second bus bar 314, the second bus bar 332 of the at least one first bus bar 300, and the second set of data bus bars or data pins 334 of the least one at least one first bus bar 300) and the corresponding electrical plug 344 of the electrical connector 336. Ultimately, the electrical buses (e.g., at least one first bus bar 300, at least one second bus bar 314, data bus bars or data pins 330, etc.) are configured to deliver power or data to one or more modular components that are securable to and movable along the vehicle frame or rail 30.

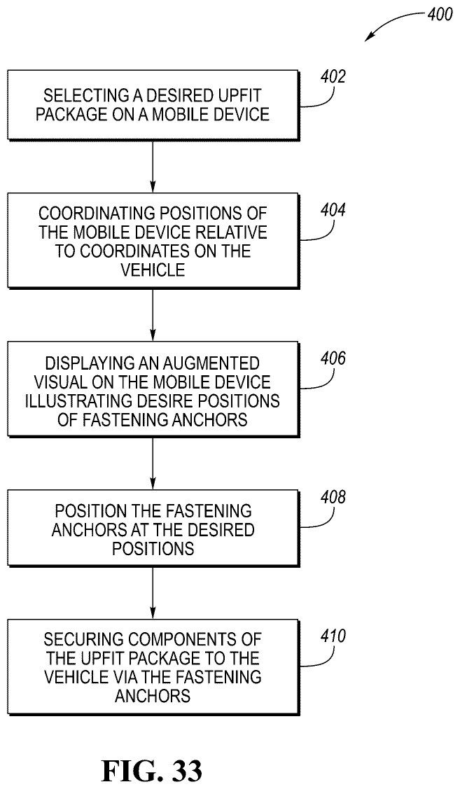

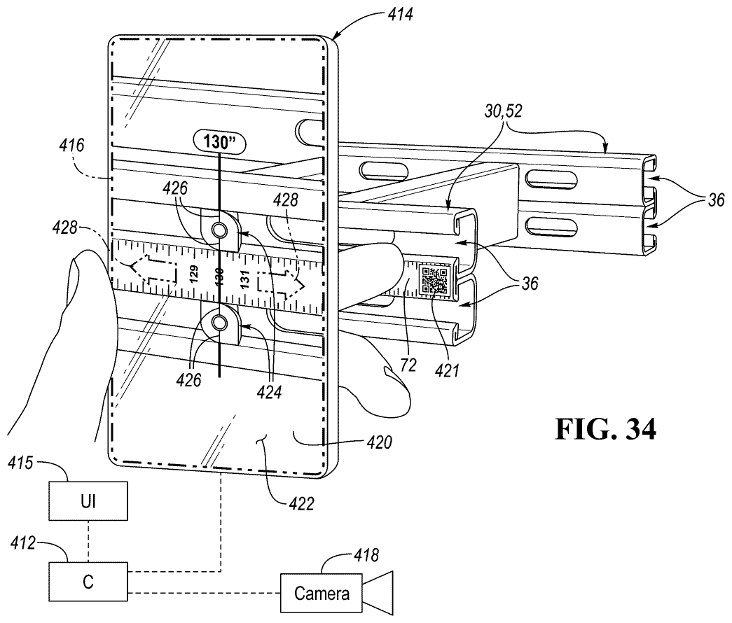

Referring to FIGS. 33 and 34, a method 400 for installing an upfit package (e.g., service body 134, weld body/flatbed 139, dump box 140, box body, ambulance body, custom upfit package, etc.) or modular equipment configurations onto the vehicle 10 is illustrated. The method 400, or at least a portion of the method 400, may be stored as control logic, algorithms, and/or instructions on a non-transitory computer readable medium that may be executed by a processor or controller 412. The controller 412 may be part of or installed onto a mobile device 414 (e.g., a smartphone, tablet, personal assistant device, laptop computer, etc.). The controller 412 may implement the method 400 by controlling the various elements or other subcomponents of the mobile device 414.

While illustrated as one controller, the controller 412 may be part of a larger control system and may be controlled by various other controllers. It should therefore be understood that the controller 412 and one or more other controllers can collectively be referred to as a “controller” that controls functions of the mobile device 414. The controller 412 may include a microprocessor or central processing unit (CPU) in communication with various types of computer readable storage devices or media (e.g., a non-transitory computer readable medium having instructions stored thereon). Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 412 in controlling the mobile device 414.

Control logic or functions performed by the controller 412 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based controller, such as controller 412. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the mobile device 414. The computer-readable storage devices or media may include one or more of a number of known physical devices which utilize electric, magnetic, and/or optical storage to keep executable instructions and associated calibration information, operating variables, and the like.

The controller 412 may be configured to receive inputs from users or sensors via electrical signals. The electrical signals may be delivered to the controller 412 via input channels. The electrical signals received from users may be indicative of a request or a command to perform a desired function while the electrical signals received from sensors may be indicative of an existing state or condition. The controller 412 includes output channels that are configured to deliver requests or commands (via electrical signals) to the various components of the mobile device 414. The controller 412 includes control logic and/or algorithms that are configured to generate the requests or commands delivered through the output channels based on the requests, commands, conditions, or states received via the input channels.

The method 400 may be part of an application program or app that is downloadable to the mobile device 414. Such an app may be purchased from an app store. The app may allow a user to create an account, may have a sign in page, and may include a home page. Such a home page may allow a user to select between shopping for components (e.g., components for a predetermined modular equipment package, upfit package or a custom upfit package), creating a custom modular equipment or upfit package, utilizing the app to install a modular equipment or upfit package, etc. The app may further include functionality to save such a custom design, proceed to a checkout page to pay for the selected items, enter in shipping information, run a quality check to ensure the selected components are compatible, etc.

The method 400 begins at block 402 where a desired modular equipment or upfit package is selected. At block 402, the controller 412 or corresponding processor may have inputs configured to receive input signals identifying a desired modular equipment or upfit package for installation onto the frame 12 of the vehicle 10 via a control or user interface 415 on the mobile device 414. The user interface 415 may include control buttons, knobs, dials, touchscreens, etc. on the mobile device 414, and a user may be configured to engage the user interface 415 to select the desired modular equipment or upfit package (e.g., one the predetermined upfit packages illustrated herein or a custom upfit package).

The desired modular equipment or upfit package may be a preexisting configuration (e.g., service body 134, weld body/flatbed 139, dump box 140, box body, ambulance body, etc.) or may be a custom design. Selecting the desired modular equipment or upfit package may correspond to providing input to the mobile device 414 to select a desired modular equipment or upfit package. Each modular equipment or upfit package may have a plurality of components. The plurality of components is configured for installation onto the vehicle 10 via the fastening anchors 40 engaging slots (e.g., T-slots 36 or T-slots 76) defined by frame rails (e.g., the first and second opposing rails 30 or the third and fourth opposing rails 74) on the vehicle 10. The desired modular equipment or upfit package defines desired positions at defined spatial coordinates (e.g., at the corresponding measurement marks 72) on the vehicle 10 for placement of the fastening anchors onto the vehicle 10 (or more specially within the T-slots 36 defined by rails 30 or rails 74) for mounting the components of the desired modular equipment or upfit package to the frame rails.

The mobile device 414 has a field-of-view 416 for scanning the defined spatial coordinates on the vehicle 10. More specifically, the mobile device 414 may have a camera 418 and a display screen 420, where the camera 418 is configured to scan the defined spatial coordinates on the vehicle 10, the field-of-view 416 is a field-of-view of the camera 418, and the field-of-view 416 is displayed on the display screen 420. The camera 418 and display screen 420 may each be in communication with the controller 412. The display screen 420 may be a touch screen that is configured to both display information and receive an input from a user. The camera 418, user interface 415, and controller 412 are illustrated schematically in FIG. 34 for illustrative purposes. However, it should be understood that the camera 418, user interface 415, and controller 412 may each be integrated into the mobile device 414, and that the lens of the camera 418 is facing away from a backside of the mobile device 414 and toward one of the rails 30 in FIG. 34.

The method 400 next moves block 404 where the positions of the mobile device 414 relative to defined spatial coordinates (e.g., the corresponding measurement marks 72 on the rails 30) on the vehicle 10 are coordinated or oriented relative to each other. At block 404, the controller 412 or corresponding processor may have inputs configured to receive input signals to that coordinate or orient the field-of-view 416 of the mobile device 414 with the defined spatial coordinates on the vehicle 10 (or more specifically on the vehicle frame 12). The input signals configured to coordinate or orient the field-of-view 416 of the mobile device 414 with the defined spatial coordinates on the vehicle 10 may correspond to the mobile device 414 (or more specifically the camera 418) scanning a marker or code 421 displayed on the vehicle 10. The code 421 may be a barcode (e.g., a one-dimensional bar code or a two-dimensional bar code) positioned on the rails 30. A two-dimensional bar code may correspond to a quick response (QR) code.

More specifically at block 404, the spatial coordination occurring at block 404 facilitates the mobile device 414 (or more specifically the display screen 420) outputting an augmented reality or augmented visual 422 overlaying representations 424 of the fastening anchors 40 at the desired positions on the corresponding spatial coordinates on the vehicle 10 within the field-of-view 416 of the mobile device 414. Even more specifically, the control logic within the controller 412 or processor is configured to overlay the representations 424 of the fastening anchors 40 of the desired modular equipment or upfit package onto the defined spatial coordinates on the vehicle frame 12 within the field-of-view 416 of the mobile device 414 to generate the augmented visual 422.

Next, at block 406 the method 400 includes scanning the vehicle 10 (or more specifically the rails 30) with the mobile device 414 along the defined spatial coordinates (e.g., along the corresponding measurement marks 72) to reveal the representations 424 of the fastening anchors 40 at the desired positions when the representations 424 of the fastening anchors 40 at the desired positions are within the field-of-view 416 of the mobile device 414. Block 406 includes relating the representations 424 of the fastening anchors 40 via displaying the augmented visual 422 on the display screen 420 of the mobile device 414 when the real-world desired positions of the fastening anchors 40 (e.g., the real-world or actual physical positions of the measurement marks 72) are within the field-of-view 416 of the mobile device 414.

At block 406, the controller 412 or corresponding processor may have outputs configured to transmit output signals to the mobile device 414 (or more specifically to the display screen 420) indicative of the augmented visual 422 within the field-of-view 416 of the mobile device 414. The output signals as displayed illustrate the desired positions for the fastening anchors 44 along the defined spatial coordinates on the vehicle 10 (or more specifically the spatial coordinates on the rails 30, such as the measurement marks 72) within the field-of-view 416 of the mobile device 414. The augmented visual 422 corresponds to overlaying an augmented reality, indicative of or based on the desired modular equipment or upfit package, onto the defined spatial coordinates on the vehicle 10 (or more specifically the spatial coordinates on the rails 30) within the field-of-view 416 of the mobile device 414.

Revealing the representations 424 of the fastening anchors 40 at the desired positions via the augmented visual 422 at block 406 may also include illustrating an alignment between positioning marks 426 on the fastening anchors 40 and the measurement marks 72 along the frame rails 30. Such positioning marks 426 may be illustrated on the representations 424 of the fastening anchors 40 in the augmented visual 422 and may also physically exist on the anchors 40.

The output signals to the mobile device 414 at block 406 may also include updating the augmented visual 422 in response to reorienting the mobile device 414 such that the augmented visual maintains 422 the representations 424 of the fastening anchors 40 at the desired positions for the fastening anchors 40 (e.g., the representations 424 of the fastening anchors 40 within the augmented visual 422 remain at the desired locations as the frame of reference displayed on the display screen changes due to changes in position of the mobile device 414 and the corresponding camera 418). The output signals to the mobile device 414 at block 406 may further include the augmented visual 422 displaying one or more arrows 428 pointing towards the closest desired positions for the fastening anchors 40 in response none of the desired positions for the fastening anchors 40 being within the field-of-view 416 of the mobile device.

Next, the method moves on to block 408 where the fastening anchors 40 are positioned within the slots (e.g., T-slot 36 or T-slots 76) at the desired positions along the vehicle 10 or frame 12 (e.g., along the rails 30 or rails 74). The method 400 then moves on to block 410 where the plurality of components of the selected modular equipment or upfit package (e.g., service body 134, weld body/flatbed 139, dump box 140, box body, ambulance body, custom modular equipment or upfit package, etc.) are secured to the vehicle 10 or frame 12 (e.g., along the rails 30 or rails 74) via fasteners 42 engaging the plurality of components and the fastening anchors 40 as positioned at the desired positions.

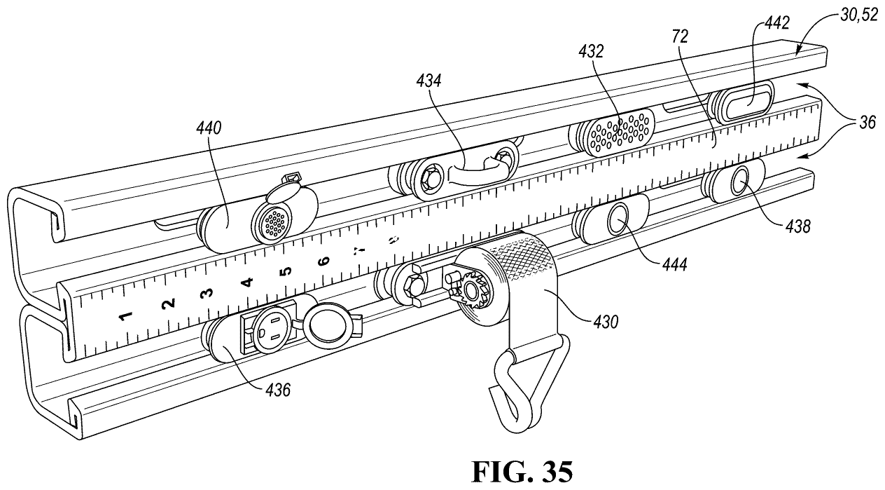

Referring to FIG. 35, a plurality of accessories that may be attached to a frame rail (e.g., rails 30 or rails 74) are illustrated. Each accessory may engage a T-slot (e.g., T-slot 36 or T-slots 76) in a manner similar to the fastening anchors 40 to secure the accessories to the vehicle 10 along the frame 12 (e.g., along one of the rails 30 or one of the rails 74). Alternatively, the accessories may be secured to the vehicle 10 along the frame 12 via fasteners 42 engaging the accessories and fastening anchors 40 disposed within the T-slots. The accessories may include rachet straps 430, lights 432, tie downs 434, 12-volt plugs 436, cameras 438, 19 pin connectors 440, global positioning (GPS) sensors 442, and sensors 444. Such sensors 444 may be configured to detect objects (e.g., other cars, objects in the road, trees, etc.) in the proximity of the vehicle 10. The sensors 444 could be radars sensors, sonar sensors, lidar sensors, etc.

The system described herein allows an end user to quickly install or swap out modular equipment or upfit configurations without permanently altering the underlying structure of the vehicle or frame. For example, an end user may mount the various components of the modular equipment or upfit packages to the frame via the fastening anchors 40 engaging the T-slots 36, which eliminates the need to drill through the frame or chassis to mount the various components of the modular equipment or upfit packages to the frame or chassis. This decreases the time required to install a desired modular equipment or upfit package and eliminates the possibility of drilling into electrical components, such as a high-voltage battery pack. This also eliminates the possibility of drilling into any component where the structural integrity of the component may be compromised.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
a frame having a rail extending longitudinally between forward and rearward regions of the vehicle, the rail defining a T-slot having a head region and a neck region, wherein the T-slot is configured to receive fasteners for mounting vehicle subcomponents and subsystems to the frame;
a first sleeve having a first open end defining a first slot, having at least one first bus disposed along an interior surface of the first sleeve within the first slot, and disposed within the T-slot along a first side of the head region;
a second sleeve having a second open end defining a second slot, having at least one second bus disposed along an interior surface of the second sleeve within the second slot, and disposed within the T-slot along a second side of head region; and
an electrical connector having a base, electrical contacts disposed on an exterior surface of the base, and an electrical socket extending from the base, wherein a first region of the base is disposed within the first slot such that a first portion of the electrical contacts engages the at least one first bus, a second region of the base is disposed within the second slot such that a second portion of the electrical contacts engages the at least one second bus, and the engagement between the electrical contacts and the at least one first and second buses establishes an electrical connection between the at least one first and second buses and the electrical socket, wherein the electrical connector is movable within the first and second sleeves along the rail, and wherein the electrical socket is configured to receive an electrical connector to deliver power or data to a modular component that is securable to and movable along the rail.

2. The vehicle of claim 1, wherein the socket extends through the neck region of the T-slot.

3. The vehicle of claim 1, wherein the rail includes a web and pair of flanges, the web is positioned opposite of the neck region of T-slot, the web defines an orifice, and the socket extends through the orifice and away from the web on an opposing side of the web relative to the T-slot.

4. The vehicle of claim 1, wherein a primary bus of the at least one first bus is configured to deliver electrical power at a first output level and a secondary bus of the at least one second bus is configured to deliver electrical power at a second output level that is greater than the first output level.

5. The vehicle of claim 2, wherein a tertiary bus of the at least one first bus or a tertiary bus of the at least one second bus is a ground connection.

6. The vehicle of claim 1, wherein a primary bus of the at least one first bus is configured to deliver electrical power and a secondary bus of the at least one second bus is configured to transmit data.

7. The vehicle of claim 6, wherein a tertiary bus of the at least one first bus or a tertiary bus of the at least one second bus is a ground connection.

8. The vehicle of claim 6, wherein a tertiary bus of the at least one first bus or a tertiary bus of the at least one second bus is configured to transmit data.

9. An electrical system for a vehicle comprising:
a first sleeve disposed within a channel defined by a vehicle frame, extending longitudinally in a first direction between forward and rearward regions of the vehicle, and defining a first slot, wherein the first slot extends longitudinally in the first direction between the forward and rearward regions of the vehicle, the first slot is open along an edge of the first sleeve, and the edge of the first sleeve faces laterally relative to the first direction;
at least one first electrical bus disposed in the first slot;
a second sleeve disposed within the channel defined by the vehicle frame, spaced-apart from the first sleeve, extending longitudinally in the first direction between the forward and rearward regions of the vehicle, and defining a second slot, wherein the second slot extends longitudinally in the first direction between the forward and rearward regions of the vehicle, the second slot is open along an edge of the second sleeve, and the edge of the second sleeve faces laterally relative to the first direction and toward the edge of the first sleeve; and
at least one second electrical bus disposed in the second slot, wherein the at least one first electrical bus and the at least one second electrical bus are configured to deliver power or data to one or more modular components that are securable to and movable along the vehicle frame.

10. The electrical system of claim 9 further comprising an electrical connector having a base, electrical contacts disposed on an exterior surface of the base, and an electrical plug extending from the base, wherein (i) the base is disposed within the first and second slots and (ii) the electrical contacts engage the first and second buses to establish an electrical connection between the first and second buses and the electrical plug, wherein the electrical connector is movable within the first and second sleeves along the frame to establish an electrical connection and deliver power or data to the one or more modular components.

11. The electrical system of claim 10, wherein the electrical plug extends outward from the channel and laterally relative to the first direction.

12. The electrical system of claim 9, wherein a primary bus of the at least one first electrical bus is configured to deliver electrical power at a first output level and a secondary bus of the at least one second electrical bus is configured to deliver electrical power at a second output level that is greater than the first output level.

13. The electrical system of claim 12, wherein a tertiary bus of the at least one first electrical bus or a tertiary bus of the at least one second electrical bus is a ground connection.

14. The electrical system of claim 9, wherein a primary bus of the at least one first electrical bus is configured to deliver electrical power and a secondary bus of the at least one second electrical bus is configured to transmit data.

15. The electrical system of claim 14, wherein a tertiary bus of the at least one first electrical bus or a tertiary bus of the at least one second electrical bus is a ground connection.

16. The electrical system of claim 14, wherein a tertiary bus of the at least one first electrical bus or a tertiary bus of the at least one second electrical bus is configured to transmit data.

17. A vehicle electrical system comprising:
a first sleeve extending longitudinally between first and second ends, defining a first slot extending longitudinally between the first and second ends, wherein the first slot is open along a lateral side of the first sleeve;
at least one first bus bar disposed within the first slot and extending longitudinally between the first and second ends;
a second sleeve extending longitudinally between third and fourth ends, defining a second slot extending longitudinally between the third and fourth ends, wherein the second slot is open along a lateral side of the second sleeve; and
at least one second bus bar disposed within the second slot and extending longitudinally between the third and fourth ends, wherein the at least one first and second bus bars are configured to collectively engage an electrical connector that is disposed within the first and second slots, wherein the electrical connector is movable within the first and second sleeves to deliver power or data to a modular component that is movable between various positions.

18. The vehicle electrical system of claim 17, wherein a primary bus bar of the at least one first bus bar is configured to deliver electrical power at a first output level and a secondary bus bar of the at least one second bus bar is configured to deliver electrical power at a second output level that is greater than the first output level.

19. The vehicle electrical system of claim 17, wherein a primary bus bar of the at least one first bus bar is configured to deliver electrical power and a secondary bus bar of the at least one second bus bar is configured to transmit data.

20. The vehicle electrical system of claim 19, wherein a tertiary bus bar of the at least one first bus bar or a tertiary bus bar of the at least one second bus bar is configured to transmit data.
